(19) United States
(12) Patent Application Publication
(10) Pub. No.: US 2005/0147247 A1
(43) Pub. Date: Jul. 7, 2005

(54) Interactive television systems having POD modules and methods for use in the same

(76) Inventors: Thomas E. Westberg, Stow, MA (US); Douglas Macrae, Weston, MA (US); Klaus Renner, Hollis, NH (US); Shawn P. O'Neil, Danville, NH (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 10/990,290

(22) Filed: Nov. 15, 2004

Related U.S. Application Data
(60) Provisional application No. 60/520,433, filed on Nov. 14, 2003.

(51) Int. Cl. B60L 1/00

(52) U.S. Cl. 380/200

(57) ABSTRACT

The present invention relates to television systems and methods, and more particularly, to interactive television systems having user equipment that includes a point of deployment (“POD”) host device and POD modules for use in conjunction with the POD host device. The interactive televisions systems may have different user equipment arrangements for supporting one or more POD modules. The POD modules may provide a user of the interactive television system with access to various programs and services. The POD module may also implement a back-channel communications link with a service provider. The POD module may also receive modules which may upgrade the hardware or software of the interactive television system.

### CROSS REFERENCE TO RELATED APPLICATIONS

This application claims the benefit of U.S. provisional patent application No. 60/520,433, filed Nov. 14, 2003, which is hereby incorporated by reference herein in its entirety.

### BACKGROUND OF THE INVENTION

This invention relates to television systems and methods, and more particularly, to interactive television systems having user equipment that includes a point of deployment (“POD”) host device and POD modules for use in conjunction with the POD host device.

Generally, set-top boxes selectively allow or deny access to television programming and data services depending on the level of service to which a subscriber has subscribed. Television programming and other information that are received through a cable input to the set-top box are typically broadcast in an encrypted, secure, or otherwise proprietary format. That is, a service provider prevents theft of its television programming and other information by transmitting its signals in a proprietary way such that someone intercepting them without a set-top box and a subscription to the service cannot view them. Conventionally, subscribers obtain a set-top box from the service provider that is programmed to decode and decrypt the programming and other information using the system provider's proprietary methods.

Modern set-top boxes, however, vary in the type and scope of features that they provide. One drawback of the service provider requiring that subscribers use a given set-top box is that the subscribers do not have any options, i.e., they are limited to the set-top box chosen by the system provider. Should the subscriber desire a more advanced set-top, he or she typically has no recourse.

Therefore, it may be desirable to remove from the set-top box those functions that are specific to the service provider (e.g., signal decryption), and to put such functions on an auxiliary device that is provided by the service provider and that operates in conjunction with user equipment. This preferably allows subscribers to choose their user equipment while still allowing the service provider to have control over proprietary functions.

It may also be desirable to allow the interactive television applications implemented on such user equipment to use the features of an auxiliary device to provide users with advanced features.

### SUMMARY OF THE INVENTION

Interactive television systems having user equipment that includes a POD host device and POD modules for use in conjunction with the POD host device may be provided in accordance with the present invention.

In one aspect of the invention, the POD module, when used in conjunction with the POD host device, may be capable of authorizing and de-authorizing the decryption or descrambling of services, such as programming, interactive television services, digital music, and events. For example, the POD module, may authorize the decryption of premium television programming delivered to the POD host device.

The POD host device may support plug-and-play functionality to automatically identify and configure the POD module. A user may have the ability to upgrade interactive television services or interactive television applications by installing or exchanging POD modules. The user may be able to perform this upgrade without the aid of a technician.

The user equipment, having the POD host device operative to receive the POD module, may have any number of different arrangements. The POD host device may be included within the user equipment or may be connected to the user equipment by a suitable wired or wireless communications link or by multiple communications links. The communications links may be secure to prevent unauthorized access to decrypted or descrambled services. The user equipment may also be adapted to receive multiple POD modules. The user equipment may use the multiple POD modules simultaneously or may manually or automatically switch between the POD modules. Further, non-POD-configured user equipment may be connected to a POD module using an adaptor.

The POD module and the POD host device may communicate via an internal input/output (I/O) to provide the user with services and features, such as interactive television services, individual programs, digital music, pay-per-view programming, and on demand programming. With this I/O, the POD module may be able to control the POD host device and other elements of the user equipment. For example, the POD module may direct the user equipment to tune a television tuner to a particular channel.

In another aspect of the invention, the POD module may include or implement a back-channel device to transmit data from the POD module back over a cable network to a service provider. A back-channel device may communicate with the service provider to transmit, for example, orders for service upgrades, requests for billing information, requests for ratings information, requests for additional program information, product or programming orders, user information, or other suitable orders, requests, or information. The back-channel device may include an external device connected to the POD module. The back-channel device may be controlled by the POD module to ensure that all communication over the cable network conforms to a strict protocol to avoid any disruptions in the cable network. Other types of external back-channel links may also be connected to the POD module.

In another arrangement of the invention, the POD module may include ports, slots, connectors, and circuitry to achieve additional functionality. For example, the POD module may include communications circuitry to communicate in any suitable protocol over any suitable medium with other data networks or equipment. The communications circuitry may be modular to allow users to connect different communications circuitry to the POD module based on their communications requirements. The POD module may also be adapted to receive other modules that provide upgrades to the hardware or software of the POD modules. For example, as a security measure, a service provider may distribute new decryption keys or codes on a chip for insertion into the POD module.

In another aspect of the invention, the POD module may communicate with the user by displaying information on a display of the user equipment. The POD module may generate display screens or may direct the POD host device to generate display screens that are displayed on a video display of the user equipment.

In another aspect of the invention, the POD module may have a POD application that supplements or coordinates with the features of one or more applications running on the POD host device. The POD application may be provided on the POD module initially, or may be downloaded after the POD module is inserted. The POD application may also provide features to an interactive television application running on the POD host device or another piece of user equipment. Providing an interactive television application on a POD module may allow service providers to maintain the same level of control as they currently have over their proprietary interactive television applications provided on non-POD configured set-top boxes. Service providers may also provide POD modules to update the interactive television application running on the host device.

In another aspect of the invention, the POD module may be programmed to implement parental control features. While most television systems are equipped with their own parental control systems, it may be desirable to effectively restrict programming and/or content using the POD module.

In another aspect of the invention, the POD module may provide enhanced recording features. When recording a program, the POD application may record an identification code unique to the POD module along with the recorded program. When the user desires to play back the program, the same POD module must be inserted to play back the recorded program. Further techniques for selectively permitting the playback of user-recorded or pre-recorded programs may also be provided by the POD module.

In another aspect of the invention, programs may be decoded, whether during real-time viewing by the user, or on playback from a storage device, using decryption keys. These keys may be generic to any POD module or may be programmed in each individual POD module, group of POD modules, or class of POD modules. A POD module may contain one or more decryption keys for accessing encoded programming, services, and/or other suitable information to which the user has subscribed. Keys may be re-programmed or added, for example, at a predetermined time (e.g., every day, every week, every month, etc.) by the service provider as a security measure or to modify a user's access. Keys may also be distributed to users for particular events, such as special pay-per-view events, which are valid for that particular event.

In another aspect of the invention, a service provider may provide pre-paid services (e.g., pre-paid basic cable) on POD modules (also referred to as “pre-paid POD modules”). Pre-paid POD modules may be disposable. A new POD module may be purchased with each pre-paid service. Pre-paid POD modules may also be reusable. For example, a reusable POD module may be re-activated by inserting a new chip, such as an EEPROM or Flash chip, into the POD module or by entering a new key or code. Reusable pre-paid POD modules may also be activated and re-activated using any other suitable approach.

In another aspect of the invention, POD modules may be used to support a video game system. In one example, one or more games may be encoded onto a POD module. User input for the video game may be received through a general or special IR remote controller device that communicates with the user equipment or may be connected directly to the POD host device. In another example, games for the video game system may be on separate POD modules (e.g., for multiple POD module systems).

Further features of the invention, its nature and various advantages will be more apparent from the accompanying drawings and the following detailed description of the preferred embodiments.

### BRIEF DESCRIPTION OF THE DRAWINGS

FIG. 1 is an illustrative arrangement for user equipment configured to receive point-of-deployment (“POD”) modules in accordance with the present invention.

FIG. 2 is another illustrative arrangement for user equipment configured to receive POD modules in accordance with the present invention.

FIG. 3 is an illustrative arrangement for user equipment configured to receive multiple POD modules in accordance with the present invention.

FIG. 4 is an illustrative arrangement for user equipment configured to receive multiple POD modules arranged in a daisy chain configuration in accordance with the present invention.

FIG. 5 is an illustrative arrangement for user equipment configured to receive a POD module by using an adaptor in accordance with the present invention.

FIG. 6 is an illustrative block diagram of various components of a POD host device and a POD module in accordance with the present invention.

FIG. 7 is an illustrative example of a digital packet in accordance with the present invention.

FIG. 8 is an illustrative block diagram of various components of a POD host device and a POD module having a multiplexer for routing demodulated packets to the decoder without sending the packets through the POD module in accordance with the present invention.

FIG. 9 is an illustrative block diagram showing various components of user equipment having a back-channel device external to the POD host device in accordance with the present invention.

FIG. 10 is an illustrative external back-channel device in accordance with the present invention.

FIG. 11 is an illustrative block diagram of a a POD module having additional ports, slots, and circuitry in accordance with the present invention.

FIG. 12 is a illustrative block diagram of communications circuitry in accordance with the present invention.

FIG. 13 is an illustrative flow diagram for decrypting or decoding an encoded program in accordance with the present invention.

FIG. 14 is an illustrative display screen that may be displayed upon the insertion of a POD module in accordance with the present invention.

FIG. 15 is an illustrative error display screen that may be displayed upon the insertion of a POD module in accordance with the present invention.

FIG. 16 is an illustrative flow diagram for decrypting or decoding encoded media in accordance with the present invention.

FIG. 17 is an illustrative interactive television program guide display screen in accordance with the present invention.

FIG. 18 is an illustrative arrangement for a set-top box configured to receive a POD module in accordance with the present invention.

FIG. 19 is another illustrative arrangement for a set-top box configured to receive a POD module in accordance with the present invention.

FIG. 20 is an illustrative arrangement for a personal computer configured to receive a POD module in accordance with the present invention.

FIG. 21 is a more generalized arrangement of illustrative user equipment in accordance with the present invention.

### DETAILED DESCRIPTION OF THE PREFERRED EMBODIMENTS

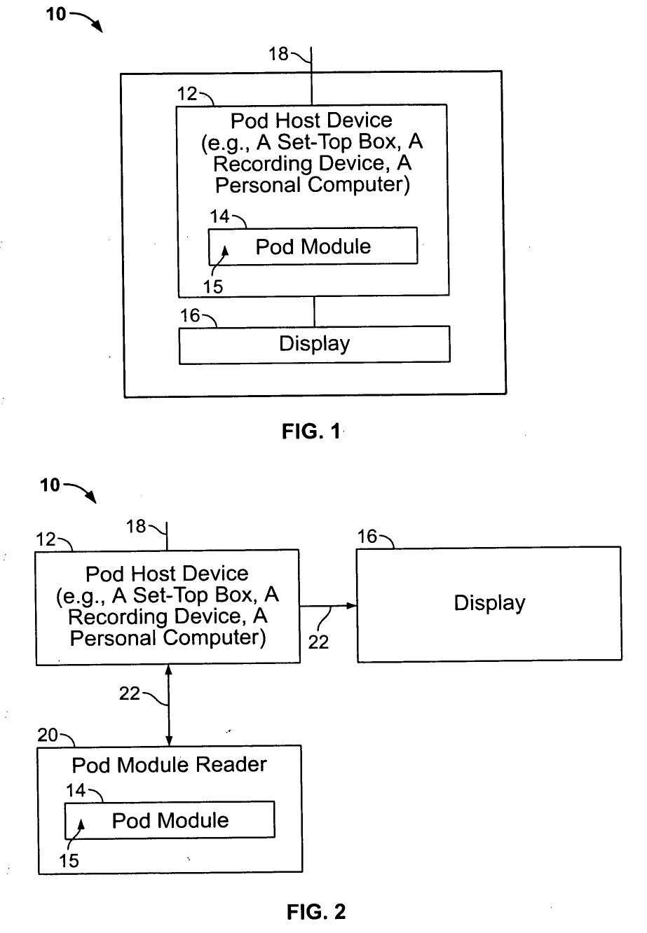

Illustrative arrangements for user equipment configured to receive point-of-deployment (“POD”) modules in accordance with two embodiments of the present invention are shown in FIGS. 1 and 2. Other arrangements for user equipment may also be used.

As used herein, a POD module is an individually addressable device for authorizing and de-authorizing the decryption or descrambling of services, such as programming, interactive television services, digital music, and events, delivered to a user's home equipment. As explained below, other features may also be provided by the POD module.

Illustrative architectures for POD host devices and POD modules, a POD module interface, and application interfaces that may be used with various embodiments disclosed herein are described, for example, in the Society of Cable Telecommunications Engineers, Inc., Engineering Committee, Digital Video Subcommittee Document SCTE 28 2003 (Formerly DVS 295), entitled “HOST-POD Interface Standard,” which is hereby incorporated by reference herein in its entirety.

In the arrangement of FIG. 1, user equipment 10 includes a POD host device 12. POD host device 12 may be, for example, a set-top box, a television, a recording device, a personal computer, a personal digital assistant, a cellular telephone, or any other suitable platform. POD host device 12 includes a POD slot 14. This slot is adapted to receive a POD module 15. POD module 15 may, for example, be provided by a service provider to a user (e.g., a subscriber), and inserted by the user into POD slot 14 of POD host device 12.

After properly installing and configuring a POD module and a POD host device (if necessary), a user may access interactive television features or programming on the user's equipment in accordance with the logic of the POD module. For example, the POD module, when inserted into or connected to a POD host device, may authorize and de-authorize the decryption or descrambling of programming delivered to the POD host device via an input/output 18.

User equipment 10 of FIG. 1 may also include a display 16 for displaying television programming and other information. Display 16 may be, for example, a television, a computer monitor, or any other suitable display device.

User equipment 10 or POD host device 12 may support plug-and-play functionality to automatically identify and configure POD module 15. This may facilitate the installation or upgrade of a portion of user equipment 10 or an application running on user equipment 10. For example, a service provider may allow the user to upgrade or install an interactive television application by providing the user with a POD module. The user may exchange the module for the one currently in his or her equipment, without the aid of a technician.

FIG. 2 shows a diagram of another illustrative arrangement for user equipment in accordance with some embodiments of the present invention. In the arrangement of FIG. 2, POD host device 12 uses a POD module reader 20 to communicate with POD module 15. POD module reader 20 may be connected to POD host device 12 using a communications path 22. Similarly, POD host device 12 may be connected to display 16 using communications path 22. Communications path 22 may be, for example, a proprietary connection, a universal serial bus (USB) connection, an IEEE 1394 connection (i.e., Firewire), a small computer systems interface (SCSI) connection, a serial connection, a parallel connection, an RS232 connection, an optical connection, an Ethernet connection, a coaxial connection or any other suitable wire-based communications path using a suitable communications protocol.

in some embodiments, POD module reader 20 may be connected to POD host device 12 using a wireless connection. Any suitable wireless link or connection may be used, such as, for example, IEEE 802.11 (e.g., 802.11b, 802.11g), Bluetooth, infrared (IR), cordless links (e.g., digital enhanced cordless telecommunications (DECT) or personal wireless telecommunications (PWT) links) or any other suitable wireless communications link or protocol.

In some embodiments, there may be multiple communications paths between POD host device 12 and POD module reader 20. For example, a combination of wired and wireless communication paths may be used. It may be desirable to have certain types of communications paths instead of others for certain purposes (e.g., an IEEE 1394 connection may be desirable for transmitting and receiving digital audio and video). It may also be desirable to simultaneously use multiple communications paths. For example, an IEEE 1394 connection is provided for receiving digital audio and video, while an IR connection is provided for transmitting control signals.

While the illustrative arrangement for user equipment of FIG. 2 shows POD module reader and display 16 receiving or transmitting signals (e.g., digital audio and video) from POD host device 12, it should be noted that communications path 22 may prevent unauthorized usage and piracy. For example, television programming that is decrypted by POD module 15 may be re-encoded or re-encrypted by POD module 15 before it is transmitted over communications path 22. Communications path 22 may also detect unauthorized tapping of the television signals from path 22.

In some embodiments, communications path 22 between POD host device 12 and POD reader 20 may limit the programming that is decoded and decrypted by POD module 15. For example, premium programming may not be decoded when an insecure connection (e.g., an unencrypted connection) between POD host device 12 and POD reader 20 is used. In another embodiment, communications path 22 between POD host device 12 and POD reader 20 may alter the quality of the programming. For example, POD host device 12 may provide analog television programming instead of digital television programming.

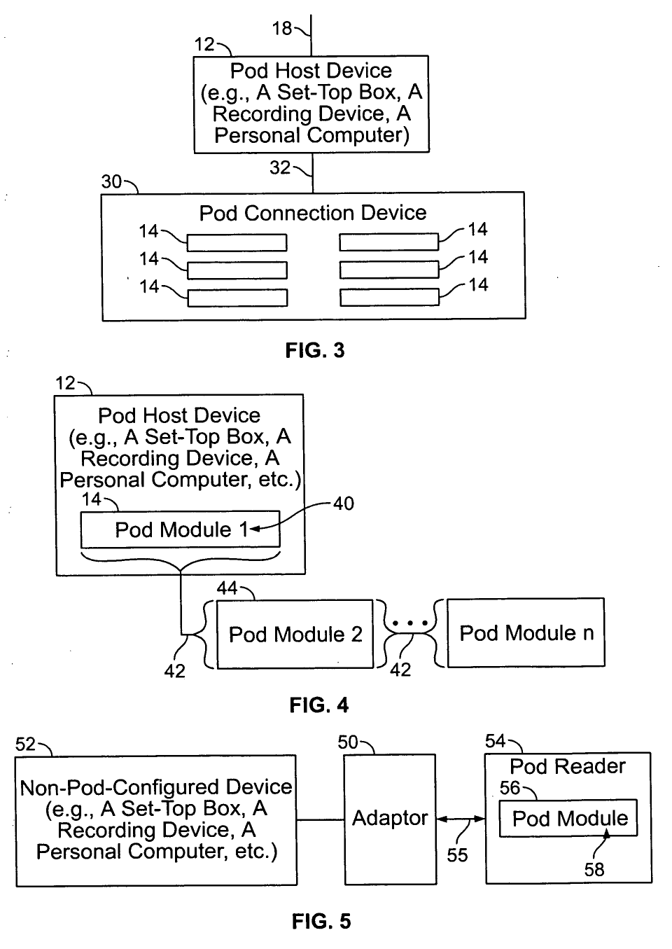

In some embodiments, POD host device 12 may be adapted to receive multiple POD modules 15. As shown in FIG. 3, multiple POD modules 15 may be connected to, for example, POD host device 12 using a POD connection device 30, such as a POD hub. POD connection device 30 may be connected to POD host device 12 using, for example, communications link 32. Communications link 32 may be, for example, a proprietary connection, a universal serial bus (USB) connection, an IEEE 1394 connection (i.e., Firewire), a small computer systems interface (SCSI) connection, a serial connection, a parallel connection, an RS232 connection, an optical connection, an Ethernet connection, a coaxial connection or any other suitable wire-based communications link using a suitable communications protocol. Alternatively, POD connection device 30 may be included as part of the POD host device (e.g., part of the television, part of the set-top box, part of the recording device, part of the computer, etc.).

POD module 15 or POD connection device 30 may re-encode or re-encrypt data that was decrypted by each POD module 15 before it is transmitted to POD host device 12 over communications link 32. Communications link 32 may also detect unauthorized tapping, splitting, or diverting of data from path 32.

In some embodiments, POD connection device 30 may be connected to POD host device 12 using a wireless connection. Any suitable wireless communications link or connection may be used, such as, for example, IEEE 802.11 (e.g., 802.11b or 802.11g), Bluetooth, infrared (IR), cordless links (e.g., digital enhanced cordless telecommunications (DECT) or personal wireless telecommunications (PWT) links) or any other suitable wireless communications link or protocol. A combination of wired and wireless communication links may also be used.

Each POD module 15 inserted into POD connection device 30 may be responsible for different system functions. For example, one POD module may contain decryption keys and decryption circuitry to decode programming and other information, and another POD module may contain communications circuitry for ordering pay-per-view programs from the service provider.

In some embodiments, POD host device 12 may have multiple tuners and each POD slot of POD connection device 30 may correspond to one of the multiple tuners. For example, one POD module may be used to decode programming currently being viewed by the user, and another POD module may be used to decode programming that is being simultaneously recorded by the user. POD connection device 30 may be configured to allow POD host device 12 to use all of the inserted POD modules 15 simultaneously, or to switch between the POD modules 15 (e.g., manually or automatically) to select one of the POD modules to use at a given time.

In some embodiments, it would be desirable for the POD host device 12 (FIGS. 1 and 2) or POD connection device 30 (FIG. 3) to facilitate fast and easy swapping of POD modules. For example, POD host device 12 may allow the user to “hot-swap” POD modules. Hot-swapping is a process in which a device, such as a POD module, may be inserted or removed from a “live” system (e.g., a POD host device). Hot-swapping facilitates interchangeability of POD modules without having to power down the respective host system.

In some embodiments, multiple POD modules may be arranged in a daisy chain configuration. As shown in FIG. 4, a first POD module 40 may be inserted into the POD slot 14 of POD host device 12. A second POD module 44 may be connected to the first POD module 40 and the system via connector 42. Connector 42 may be, for example, a proprietary connection, a universal serial bus (USB) connection, an IEEE 1394 connection (i.e., Firewire), a small computer systems interface (SCSI) connection, a serial connection, a parallel connection, an RS232 connection, an optical connection, an Ethernet connection, a coaxial connection, or any other suitable connection. Subsequent POD modules may connect to the previous POD module using additional connectors 42.

Each of the POD modules may re-encode or re-encrypt data before transmitting the data to POD host device 12 over connector 42. Connector 42 may also prevent unauthorized tapping of data from connector 42. In some embodiments, connector 42 between each of the POD modules may limit the programming that is decoded and decrypted. For example, premium programming may not be decoded when an insecure connection (e.g., an unencrypted connection) between each of the POD modules is used. In another embodiment, connector 42 between each of the POD modules may alter the quality of the programming. For example, POD host device 12 may provide analog television programming instead of digital television programming.

Using a daisy chain configuration, POD host device 12 may simultaneously use one or more POD modules. In another suitable approach, the daisy chain configuration may allow POD host device 12 to switch (e.g., manually or automatically) between the POD modules and select one of the POD modules to use at a given time.

In some embodiments, non-POD-configured devices (e.g., conventional set-top boxes) may be connected to a POD module by using an adaptor. As shown in FIG. 5, POD adaptor 50 may connect a non-POD-configured device 52 that, for example, does not have ports, buses, or other connectors suitable for connecting with a POD module, to a POD module reader 54. POD reader 54 may have a POD slot 14 that is adapted to receive a POD module 15. In some embodiments, adaptor 50 may process and convert inputs and outputs of POD reader 54 (e.g., analog-to-digital conversions or digital-to-analog conversions) to establish communications between non-POD-configured device 52 and POD reader 54. In another embodiment, POD adaptor 50 may be integrated with POD reader 54 and may allow POD reader 54 to connect directly with non-POD-configured device 52 (e.g., a USB-compatible POD reader, a serial port-compatible POD reader, a Firewire-compatible POD reader, a PCMCIA-compatible POD reader, etc.).

For example, POD reader 54 may connect to adaptor 50 using a connector 55. Connector 55 may be, for example, a proprietary connection, a universal serial bus (USB) connection, an IEEE 1394 connection (i.e., Firewire), a small computer systems interface (SCSI) connection, a serial connection, a parallel connection, an RS232 connection, an optical connection, an Ethernet connection, a coaxial connection, or any other suitable connection.

POD module 58 may re-encode or re-encrypt data before it is transmitted to adaptor 50 over connector 55. Connector 55 may also prevent unauthorized tapping of data from connector 55. In some embodiments, connector 55 may limit the programming that is decoded and decrypted. For example, premium programming may not be decoded when an insecure connection (e.g., an unencrypted connection) between POD reader 54 and adaptor 50 is used.

Adaptor 50 may allow the non-POD-configured device 52 to access or use multiple POD modules. For example, adaptor 50 may be used to connect non-POD-configured device 52 with POD connection device 30 (FIG. 3).

In some embodiments, adaptor 50 may include control buttons and switches. Control buttons and switches may allow the user to configure the connections between POD reader 54 and non-POD-configured device 52 (e.g., select particular inputs or outputs). Adaptor 50 may also include a display area that shows information related to those settings. In some embodiments, POD adaptor 50 may generate a display on the display device (e.g., display device 16 of FIG. 1) to show the configuration settings. For example, the display may inform the user that POD adaptor is currently connecting a non-POD-configured device to the IEEE 1394 connector of POD adaptor 50.

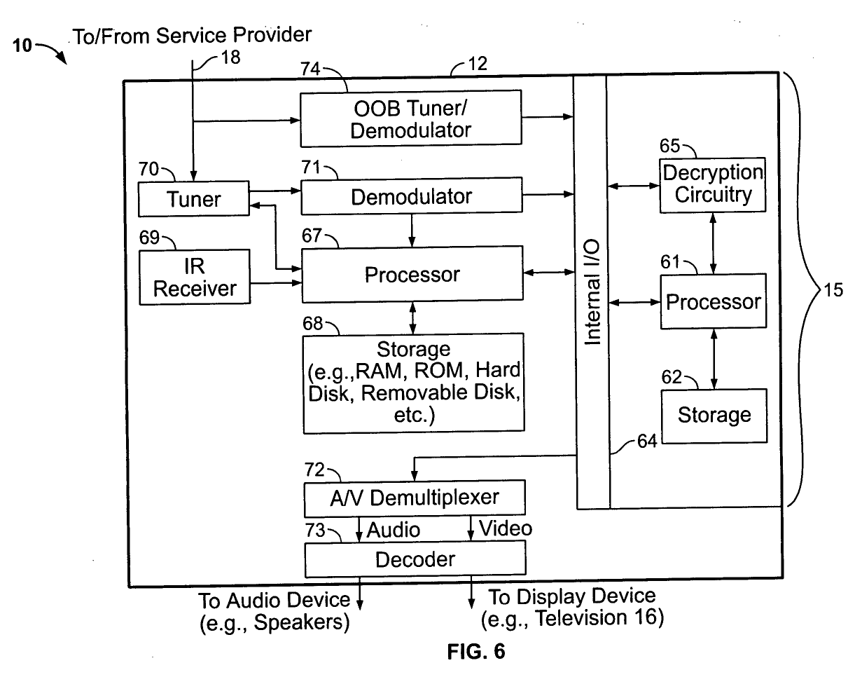

FIG. 6 shows an illustrative block diagram of various components of POD host device 12 and a POD module 15 (FIGS. 1 and 2), in accordance with some embodiments of the present invention. In this figure, a POD module 15 is inserted into POD host device 12.

POD module 15 may include a processor 61. Processor 61 may include a central processing unit (CPU), a memory controller, program memory, data memory, input/output (I/O) circuitry, analog to digital converters, and digital to analog converters, etc. Processor 61 may include any suitable microprocessor or group of microprocessors, such as an Intel Pentium® microprocessor, an AMD Athlon™ microprocessor, or a Motorola PowerPC™ microprocessor. Processor 61 may also include a microcontroller, which integrates some or all of the other circuitry of processor 61 onto one chip. The chip or chips used for processor 61 may be generic or may be designed specifically for use in the POD module. Processor 61 may contain customizable circuitry, such as, a field programmable gate array (FPGA). An FPGA may be used as an alternative to using a custom designed chip. The FPGA may be programmed and re-programmed to operate in a specified manner within processor 61.

POD module 15 may also include storage, such as storage 62. Storage 62 may be any combination of RAM, ROM, magnetic storage (e.g., a hard disk or a microdrive), removable storage, Flash memory, or any other similar device to store configuration information, data, program instructions, or any other suitable information. Storage 62 may, for example, store application instructions and application data (e.g., user-profile information, decryption keys, or other application data).

POD module 15 may also include decryption circuitry 65. Decryption circuitry 65 decrypts or decodes digital packets, which may contain television programming or other information, encrypted in the service provider's proprietary format. In some embodiments, the decryption of digital packets may also be performed by processor 61. In some embodiments, POD module 15 may use decryption circuitry 65, processor 61, or a dedicated analog decryption circuit to decrypt (or descramble) the analog signals.

In some embodiments, POD host device 12 may include multiple tuners. POD module 15 may also include multiple decryption circuits, where each decryption circuit corresponds to one of the multiple tuners. Using the multiple decryption circuits, POD module 15 may simultaneously decrypt multiple streams of television programming or other information. Alternatively, decryption circuitry 65 may decrypt multiple streams of television programming or other information. The multiple decryption circuits may be separate from the circuitry shown in FIG. 6, or may be included in, for example, decryption circuitry 65 or processor 61.

In some embodiments, decryption circuitry 65 may decode or decrypt data, such as television programming and other information, received from input/output 18 and re-encrypt the data to prevent unauthorized access to un-encoded or un-encrypted data. The re-encrypted data may be transmitted to POD host device 12 (e.g., the POD host device having decryption circuitry) that decodes or decrypts the data to be shown on display 16.

Digital packets may be transmitted to decryption circuitry 65 within POD module 15. In some embodiments, when POD module 15 has been inserted into POD slot 14 of POD host device 12, POD module 15 may be accessed to determine whether the user has access to the encoded programming or information. If, for example, POD module 15 verifies that the user has access to the encoded programming or information by having the appropriate decryption keys or codes, POD module 15 may process the packets and transmit the processed packets to POD host device 12. If POD module 15 is unable to process the packets, POD module 15 may communicate with POD host device 12 or take other actions, such as, for example, generate an error message. Alternatively, POD module 15 may transmit the unprocessed packets to POD host device 12.

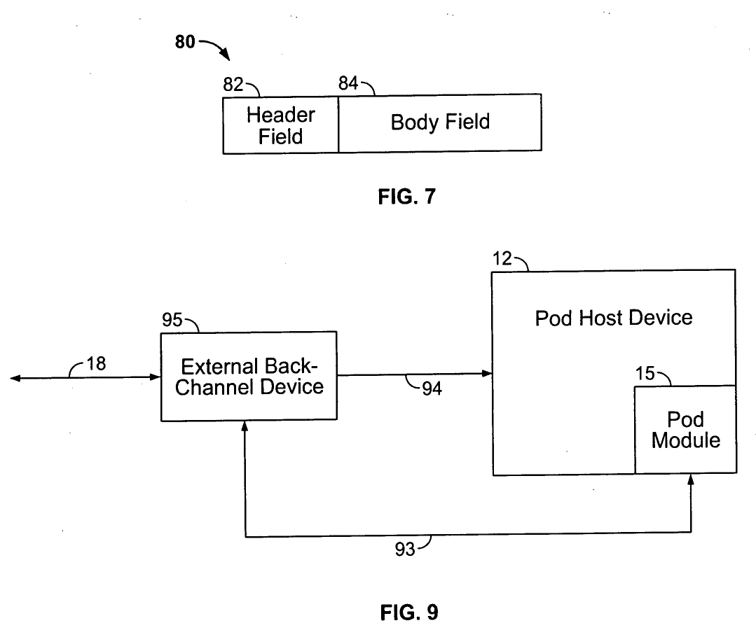

In some embodiments, the digital packets transmitted from demodulator 71 of POD host device 12 to the decryption circuitry 65 of POD module 15 may contain information relating to how the digital packets should be processed. FIG. 7 shows an illustrative example of a digital packet in accordance with some embodiments of the present invention. Digital packet 80 may include a header field 82 and a body field 84. Header field 82 may include, for example, tags that identify the data contained in body field 84. A POD module, such as POD module 15, may read header field 82 of each digital packet to determine how the data in body field 84 should be processed.

For example, if POD module 15 determines that an incoming data packet contains premium television programming, the POD module may then determine whether or not the user is authorized to view the programming before the data is processed (e.g., determine whether the user is a subscriber to the premium television service by retrieving decryption keys and using a look-up table). In response, if POD module 15 determines that the data packet contains television programming that the user is permitted to view, processor 61 may direct decryption circuitry 65 to decrypt or decode the body of the digital packet and output the result to the demultiplexer 72 in a standard format, such as MPEG-2. If the digital packet contains television programming that is not permitted to be viewed by the user, the POD module 15 may not decode or decrypt the body of the packet. In such an example, POD module 15 may direct the interactive television application to provide the user with an error message. The error message may, for example, explain why the programming was not permitted to be viewed by the user.

Referring back to FIG. 6, POD module 15 and POD host device 12 communicate via an internal input/output (I/O) 64 to provide the user with services and features, such as interactive television services, individual programs, digital music, pay-per-view programming, and on-demand programming. Internal I/O 64 may include suitable arrangement of buses, address lines, registers, buffers, stacks, and queues. Using internal I/O 64, POD module 15 and POD host device 12 may exchange data or command packets, such as television programming signals and other information, command messages, user inputs, system data, or system control information. For example, in order to authorize and de-authorize the decryption or descrambling of premium television programming, POD module 15 may receive the television signal from POD host device 12, decrypt or descramble the programming, and transmit the decrypted or descrambled programming back to POD host device 12 to be shown on display 16. In another example, POD module 15 may re-encrypt the programming and transmit the re-encrypted programming to POD host device 12. POD host device 12 may use processor 67 or any other dedicated decryption circuit to decrypt the programming to be shown on display 16. In yet another example, POD module 15 may receive the television signal from POD host device 12 and instruct POD host device 12 to decrypt or descramble the programming to be shown on display 16.

Using internal I/O circuitry 64, POD module 15 may control POD host device 12. For example, processor 61 may direct POD host device 12 to tune tuner 70 to a particular channel. In another example, processor 61 may be programmed with control information that determines which television programming, interactive television features, or applications the user has access to. Using internal I/O 64, processor 61 may transmit this information to processor 67. Processor 67 may use this information to provide the user with access to such programming, features or applications.

POD host device 12 may include, for example, a processor 67, storage 68, an infrared (IR) receiver 69, a tuner 70, a demodulator 71, a demultiplexer 72, a decoder 73, and an out-of-band tuner 74.

Processor 67 may include a central processing unit (CPU), a memory controller, program memory, data memory, input/output (I/O) circuitry, analog to digital converters, and digital to analog converters, etc. Processor 67 may include any suitable microprocessor or group of microprocessors, such as an Intel Pentium® microprocessor, an AMD Athlon™ microprocessor, or a Motorola PowerPC™ microprocessor. Processor 67 may also include a microcontroller, which integrates some or all of the other circuitry of processor 67 onto one chip. Processor 67 may be used to control the operation of all of the components, execute software applications, etc.

Storage 68 may be any combination of RAM, ROM, magnetic storage, removable storage, or similar device to store data, applications, programming, or any other suitable information.

POD host device 12 may also have IR receiver 69 for communicating with a remote control or wireless keyboard. IR receiver 69 may receive commands from a dedicated remote control, a universal remote control, etc. Some IR commands may be relayed to POD module 15 though internal I/O 64.

Input/output 18 from an antenna, cable, satellite, or any other suitable source provides signals to tuner 70. Tuner 70 may be, for example a 864 MHz analog and digital tuner. In some embodiments, multiple tuners may be provided. In some embodiments, Tuner 70 is connected to digital demodulator 71 that converts the input signals to digital signals or packets. Digital demodulator 71 may be, for example, a 64 or 256-quadrature amplitude modulation (QAM) demodulator or an ATSC 8-VSB demodulator and decoder. In some embodiments, POD host device 12 may include an analog decoder, such as, for example, a National Television System Committee (NTSC) decoder for decoding analog channels. In some embodiments, POD host device 12 may include a Vertical Blanking Interval (VBI) data decoder to extract VBI data transmitted along with analog broadcasts.

Demultiplexer 72, such as, for example, an MPEG-2 transport stream demultiplexer, separates the video signals and audio signals from the packets received from POD module 15 and transmits the separated signals to decoder 73. Decoder 73 converts the digital packets into an analog or digital audio/visual signal to be displayed on a display device (e.g., a television) and heard on an audio device (e.g., speakers). Decoder 73 may be, for example, an MPEG decoder for decoding video signals and an AC-3 decoder for decoding audio signals.

In some embodiments, an approach for routing demodulated packets to the decoder without sending the packets through POD module 15 may also be provided. For example, POD host device 12 may include a multiplexer. This approach may be used when, for example, POD module 15 is not inserted in the POD slot of POD host device 12, or if the user is requesting to view a television program or receive information that does not need to be authorized or decrypted by POD module 15.

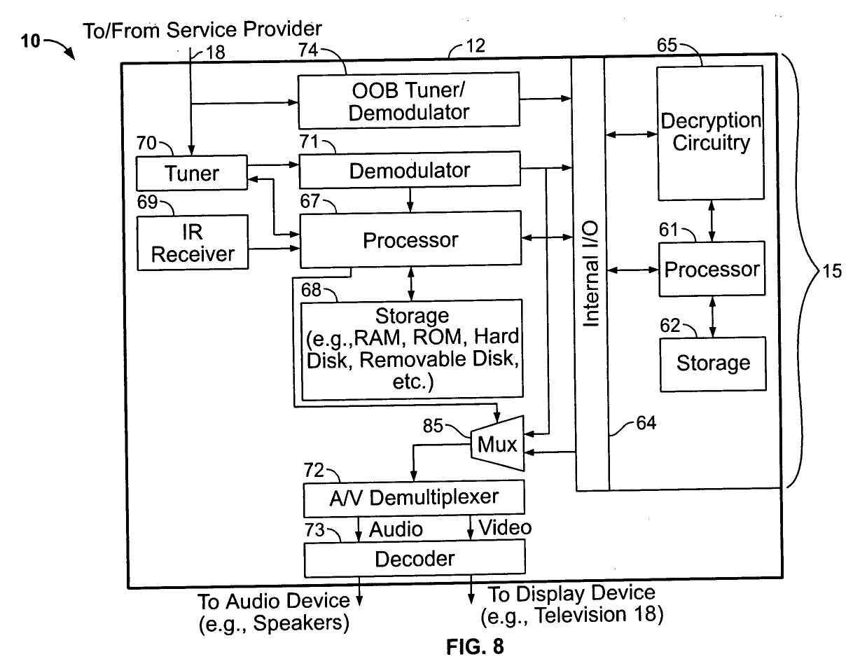

As shown in FIG. 8, multiplexer 85, under the control of processor 67, receives the demodulated packets from demodulator 71 or from decryption circuitry 65 using internal I/O 64 in POD module 15. Multiplexer 85 transmits the received packets to audio/video demultiplexer 72. Multiplexer 85 may automatically pass digital packets to demultiplexer 73 that are not addressed to the POD module in the header field 82 (FIG. 7) of a digital packet 80. For example, a public domain television program may not be encrypted. The header field of the digital packet for the public domain television program may, for example, include instructions in the header field to be transmitted directly to demultiplexer 72.

In some interactive television application systems, television distribution facilities transmit data packets that contain information used by interactive applications. Some systems transmit these packets on an out-of-band frequency. POD host device 12 may include an out-of-band (OOB) tuner and demodulator 74, such as, for example a Quadrature Phase Shift Keying (QPSK) demodulator, that tunes to this dedicated frequency and extracts the data and control packets that are transmitted from the service provider. The out-of-band data may be transmitted to processor 61 of the POD module 15 using internal I/O 64. The data relevant to POD module 15 is processed with processor 61. Data that is unused by POD module 15 may be transmitted back to POD host device 12 using internal I/O 64. In some embodiments, POD module 15, using the out-of-band data, may control a user's access to interactive applications provided by the host device or other user equipment.

In an alternative arrangement (not shown), POD host device may not include an out-of-band tuner and demodulator 74. In such an arrangement, POD module 15 may use internal I/O 64 to direct tuner 70 of the POD host device 12 to tune to the out-of-band frequency. Out-of-band data may be demodulated by demodulator 71 and transmitted to POD module 15. POD module 15 may use internal I/O 64 to direct the tuner to tune to the out-of-band frequency at times such as, for example, in-between changing channels, while the television system is not being used, when directed to by control data transmitted over the current channel, or when directed by an interactive television application running on the POD module. In embodiments where POD host device 12 has multiple tuners, one of the tuners may tune to regular television programming while the other tuner tunes to the out-of-band frequency or channel. Providing multiple tuners allows the user to view television channels while obtaining information from an out-of-band frequency.

In another arrangement, POD host device 12 may include a back-channel device. As used herein, a “back-channel” or “return channel” is a physical or logical path that a return signal may take from the POD module back to the service provider or cable headend. A back-channel device may connect with the service provider to transmit, for example, orders for service upgrades, requests for billing information, requests for ratings information, requests for additional program information, product or programming orders, user information, or other suitable orders, requests or information. The requests, orders and information may be for interactive television services and transactional electronic services, such as, for example, ordering pay-per-view programs, requesting video-on-demand programs, subscribing to premium channels, at-home shopping, providing feedback, or any other suitable interactive or transactional service.

In some embodiments, the user equipment may include an external back-channel device that is connected to POD host device 12 and POD module 15. FIG. 9 is an illustrative block diagram showing various components of user equipment having a back-channel device external to the POD host device. External back-channel device 95 may couple an input/output, such as input/output 18, to POD module 15 via communications path 93. Path 93 may use a proprietary cable connection or any other suitable communications path using a suitable communications protocol, such as, for example, a universal serial bus (USB) connection, an IEEE 1394 connection (i.e., Firewire), a small computer systems interface (SCSI) connection, a serial connection, a parallel connection, an RS232 connection, an optical connection, an Ethernet connection, or a coaxial connection. Power for external back-channel device 95 may be provided by POD module 15 over connection 93 or by an external power source. External back-channel device 95 may also have a communications path 94 that transmits the television signal of input/output 18 to POD host device 12.

POD module 15 may have a connector, such as, for example, a PCMCIA card socket, a smart card socket, an XJack® type connector, or any other suitable connector, that allows POD module 15 to connect to external back-channel device 95 over connection 93. According to one embodiment, POD module 15 that is inserted into POD slot 14 of POD host device 12 may have a connector or an embedded cable on its outside edge which protrudes out of POD slot 14. A proprietary connection may connect POD module 15 and external back-channel device 95 and carry power, control, and transmit data signals to external back-channel device 95. For example, POD module 15 may include a transmit enable signal ETX, a clock signal CTX, and differential transmission data signals ITX and QTX. Asserting signal ETX allows external back-channel device 95 to transmit the data sent on signals ITX and QTX corresponding to the timing of clock signal CTX. Similarly, other suitable sets of signals may also be used to transmit data using external back-channel device 95. Some other embodiments may also include additional signals for POD module 15 to receive data and status from external back-channel device 95.

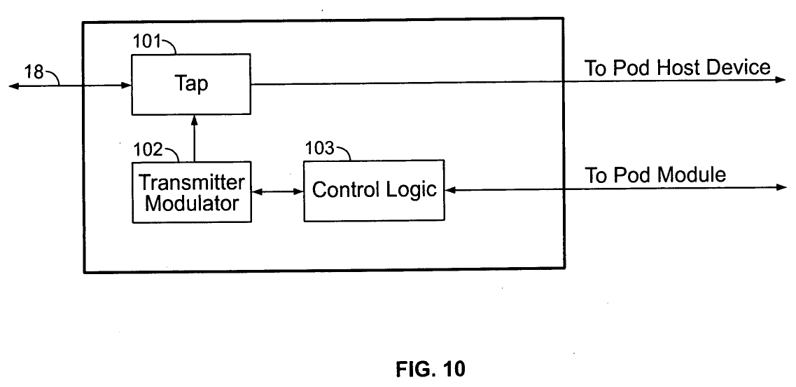

One arrangement for an external back-channel device is shown in FIG. 10. External back-channel device 95 may include, for example, a tap 101, a transmitter modulator 102, and control circuitry 103. Tap 101 transmits the input signal of input/output 18 to POD host device 12 over communications path 94. Tap 101 may also allow POD module 15 to receive out-of-band data packets from input/output 18 over communications path 93. Transmitter modulator 102 may be, for example, a QPSK modulator. Control logic 103 controls the operation of external back-channel device 95. Control logic 103 may also include inputs for receiving data and control signals from POD module 15 and outputs for sending control and status signals to POD module 15. Control logic 103 may also include, for example, a phase lock loop (PLL) to maintain a clock signal and control the frequency of external back-channel device 95, and an Inter-IC (I²C) bus to control the connection between the external back-channel device 95 and the POD module 15. The data and timing of external back-channel device 95 is controlled by POD module 15 to ensure precise control of external back-channel device 95. After properly configuring external back-channel device 95 to both input/output 18 and to POD module 15, POD module 15 and the service provider may communicate through a back-channel connection.

In some embodiments, external back-channel device may also include an out-of-band tuner and demodulator (not shown) to receive data from the out-of-band channel.

Since input/output 18 is connected to the user equipment in the local cable network, the devices wishing to transmit data on input/output 18 may communicate using a protocol specified by the cable service provider. For example, one protocol that may be used is the ALOHA protocol. As used herein, the “ALOHA protocol” is a communications scheme in which each source (transmitter) in a network sends a data packet whenever there is a data packet to send. If an acknowledgment is received by the source, the data packet has successfully reached its destination (receiver). Otherwise, if the data packet is not received at the destination (e.g., no acknowledgement is received), the data packet is sent again at a later time. For example, if the data is received by the cable headend, an acknowledgment will be received by POD module 15 through an out-of-band transmission. Otherwise, if an acknowledgement is not received, the data is retransmitted by POD module 15 at a later time.

If the data to be transmitted by POD module 15 cannot fit (e.g., is not short enough) in one protocol data unit (PDU), a message requesting to send data may be sent. When acknowledged, the cable headend informs POD module 15 of a specific timeslot for POD module 15 to transmit the data.

As this and other related protocols are time dependent, it should be noted that external back-channel device 95 should have a fast connection to POD module 15 such that the system has low latency.

Other types of external back-channel links may also be connected to POD module 15. In some embodiments, external back-channel device 95 may include, for example, a cable modem, an integrated services digital network (ISDN) modem, a digital subscriber line (DSL) modem, a telephone modem, a wireless network controller card (NIC), or other suitable controller for communicating with a remote computer (e.g., at a headend) via a back channel. External back-channel device 95, such as, for example, the QPSK modulator, may be controlled directly by POD module 15. Alternatively, external back-channel device 95 may transmit data from POD module 15 in a more autonomous approach. For example, external back-channel device 95 may receive the data to be transmitted from POD module 15, but does not receive signals regarding controlling the transmission.

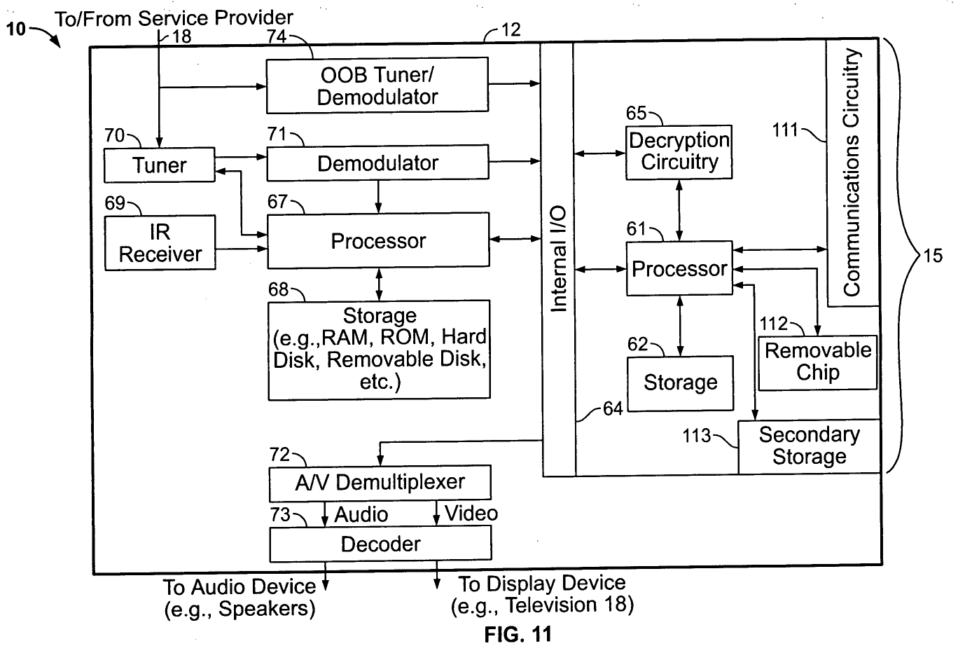

In another arrangement, FIG. 11 shows an illustrative block diagram of various components of a POD host device 12 and POD module 15, where POD module 15 also includes additional ports, slots, and circuitry. In the arrangement of FIG. 11, POD module 15 includes, for example, communications circuitry 111, a removable chip 112, and secondary storage 113.

POD module 15 may include communications circuitry 111. Communications circuitry 111 may provide an external back-channel link. Communications circuitry 111 may connect POD module 15 with the service provider to transmit, for example, orders for service upgrades, requests for billing information, requests for ratings information, requests for additional program information, product or programming orders, user information, or other suitable orders, requests or information. The requests, orders and information may be for interactive television services and transactional electronic services, such as, for example, ordering pay-per-view programs, requesting video-on-demand programs, subscribing to premium channels, at-home shopping, providing user feedback or ratings, or any other suitable interactive or transactional service.

Communications circuitry 111 may include, for example, a cable modem, an integrated services digital network (ISDN) modem, a digital subscriber line (DSL) modem, a telephone modem, a radio frequency (RF) base modem, a wireless network controller card (NIC), universal serial bus (USB) controller, IEEE 1394 controller, or other suitable controller for communicating with a remote computer (e.g., at a headend) via a back channel.

It should be noted that although communications circuitry 111 is shown as being part of POD module 15, communications circuitry 111 may be at least partially external to POD module 15. For example, communications circuitry 111 may be contained at least partially in an external back-channel device as described previously. Communications circuitry 111 may have external connectors such as, for example, coaxial connectors for connecting to input/output 18. Communications circuitry 111 may also have external connectors such as, a proprietary connector, a USB connector, an IEEE 1394 connector, a SCSI connector, a serial connector, a parallel connector, an RS232 connector, an optical connector, or and an Ethernet connector. Communications circuitry 111 may also include an external antenna for wireless connections. In one example, communications circuitry 111 may contain an RF transmitter/receiver or may be connected externally to an RF transmitter/receiver. The RF transmitter/receiver may communicate to another RF receiver/transmitter device that is connected to a land based phone line jack. The phone link jack provides the link for a modem connection to communicate with the service provider.

Communications circuitry 111 may also include circuitry suitable for communicating with other devices in the user's equipment. For example, communications circuitry 111 may receive user inputs, or transmit control signals to recording devices (e.g., a digital video recorder or VCR). Control circuitry 111 may also contain audio visual inputs and outputs which may be connected to other devices in the user's equipment.

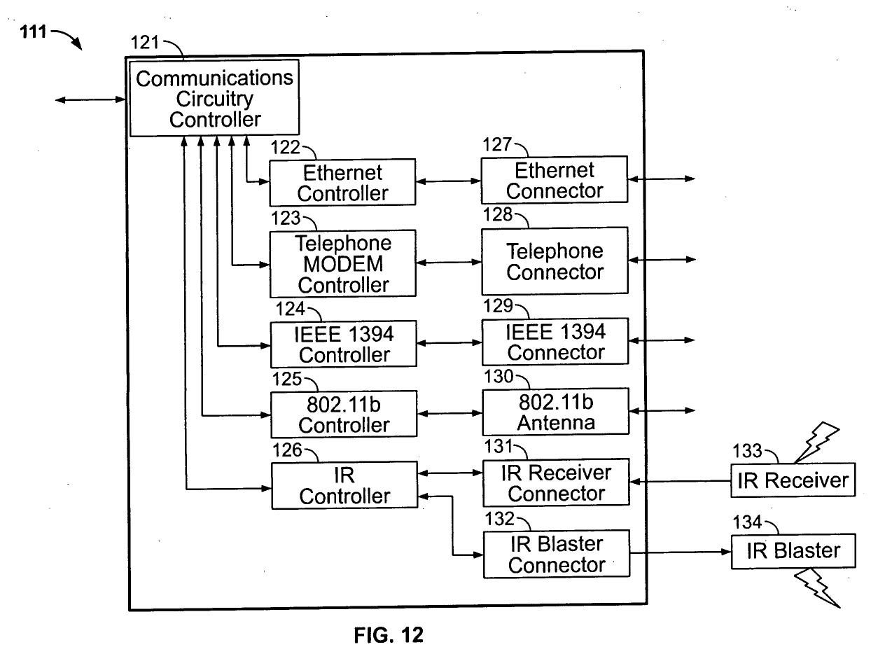

FIG. 12 shows illustrative communications circuitry 111 in accordance with some embodiments of the present invention. Communications circuitry 111 includes communications circuitry controller 121 that is connected to processor 61 (FIG. 6). Controller 121 connects to the respective controllers for each of the communications circuits within communications circuitry 111. In this embodiment, communications circuitry 111 contains an Ethernet controller 122, a telephone modem controller 123, an IEEE 1394 controller 124, an 802.11b controller 125, and an IR controller 126. Each of the communication circuit controllers connects to their respective connectors. For example, Ethernet controller 122 is connected to an Ethernet connector 127. Ethernet controller 122 and Ethernet connector 127 may be used as a back-channel device to, for example, send pay-per-view orders to the service provider. It may also, for example, connect the host device with other devices in a user's household as part of a home network.

Communications circuitry 111 may also include infrared (IR) circuitry, such as IR controller 126, an IR receiver connector 131, an IR blaster connector 132, an IR receiver 133, and an IR blaster 134. IR controller 126 is connected to IR receiver connector 131 and IR blaster connector 132. An external IR receiver 133 and an external IR blaster 134 are connected to the IR receiver connector 131 and the IR blaster connector 132, respectively, of communications circuitry 111. IR receiver 133 may receive commands from a remote control (not shown). IR blaster 134 may transmit commands to POD host device 12 or other equipment (e.g., a recording device), thereby allowing POD module 15 to control POD host device 12 or the other equipment. For example, in response to receiving a command from the remote control with IR receiver 133, processor 61 may determine that the command is related to a record operation. Processor 61 may direct the IR controller 126 to direct IR blaster 134 to transmit an infrared signal to the IR receiver of the recording device.

Returning to FIG. 11, in some embodiments, POD module 15 may include a removable secondary storage device 113. Secondary storage device 113 may be, for example, a Flash memory card (e.g., a CompactFlash card), a microdrive, a secure digital (SD) multimedia card, an extreme digital (xD) card, a synchronous direct random access memory (SDRAM) chip, a dynamic random access memory (DRAM) chip, a double data rate (DDR) SRAM chip, a floppy disk, a rewritable compact disc (CD-R), or any other suitable removable memory device. For example, inserting a secondary storage device 113 into POD module 15 increases the amount of memory available. Processor 61 may detect that secondary storage device 113 has been inserted. In response, processor 61 may determine how much memory has been added into the system by secondary storage device 113.

Secondary storage device 113 may supplement storage 62. For example, if secondary storage device 113 is a CompactFlash card, it may supplement the internal hard drive space of storage 62. In another example, if secondary storage device 113 is an SDRAM chip, it may supplement the internal memory in storage 62.

In some embodiments, system providers may allow users to upgrade existing POD modules by providing a removable chip 112. For example, POD modules may include chips that are removable and reprogrammable, such as, for example, electrically erasable programmable read-only memory (EEPROM) chips. In one example, the removable chip may contain, for example, decryption keys or codes for the use by the POD module or the POD host device. If the removable chip is an EEPROM chip, the service provider may update decryption keys by erasing the keys using ultraviolet irradiation and using an EEPROM writer to reprogram new decryption keys onto the EEPROM chip.

For example, as a security measure, a service provider may distribute new decryption keys or codes at predetermined times (e.g., every month, every year, etc.). In some embodiments, decryption keys or codes may be updated or changed by providing users with a replacement EEPROM chip for insertion into the POD module (e.g., as opposed to replacing an existing POD module). It should be noted that while this example discusses replacing a chip containing a decryption code in the POD module, any component of the POD module may be replaced, upgraded, or added using any suitable approach.

In some embodiments, POD module 15 may communicate with the user by displaying information on display 16. POD module 15 may communicate with the user by directing POD host device 12 to generate a display screen. For example, upon detection of an error, POD module 15 may communicate with POD host device 12 to have POD host device 12 generate an error message to be shown on display 16. POD module 15 may communicate the content of the error message or may select a pre-defined message of POD host device 12.

In some embodiments, POD module 15 may communicate with POD host device 12 to control what is being displayed on display 16. For example, to display an error message to the user, POD module 15 may direct POD host device 12 to resize or move the content currently displayed on display 16.

In other embodiments, POD module 15 may communicate with POD host device 12 to generate display screens. POD host device 12 may generate display screen in response to POD module 15 transmitting display screen data that is interpreted and displayed by POD host device 12. For example, POD host device 12 may contain an Hyper-Text Markup Language (HTML) interpreter and POD module 15 may transmit HTML code to be displayed by POD host device 12. Alternatively, POD host device 12 may be able to generate display screens that are defined using any suitable markup language (e.g., HyperText Markup Language (HTML), Dynamic HyperText Markup Language (DHTML), pages defined using the Extensible Markup Language (XML), JavaServer Pages (JSP), Active Server Pages (ASP), or any other suitable approaches) upon receipt of appropriate code from POD module 15.

In another embodiment POD module 15 may include video generating circuitry that may generate a video stream that may output to demultiplexer 72 and decoder 73. For example, using the video generating circuitry, POD module 15 may generate an MPEG video stream to be displayed. The generated video stream may be displayed without any interaction with processor 67 of POD host device 12 by, for example, directly outputting the generated video directly to the demultiplexer 72 of POD host device 12.

In some embodiments, the POD module may replace the video that the POD host device was currently receiving with video that the POD module generates. The audio for the currently broadcast program may continue, for example, in the background of the video generated by the POD module. In another suitable example, the audio for the currently broadcast program may be replaced by audio generated by the POD module.

In some embodiments, POD module 15 may generate a video on display 16 using other approaches. For example, POD module 15 may include circuitry for generating and sending video content directly to display 16. In another example, POD module may write the video data to the frame buffer of display 16. POD module 15 may also include video encoding hardware that allows POD module 15 to combine the generated video with television programming such that the generated video may be overlaid onto a portion of the display screen. Alternatively, the video window displaying the currently broadcast program may be resized such that the video generated by POD module 15 does not obscure the currently broadcast program.

In some embodiments, POD module 15 (FIGS. 1 and 2) may have a POD application that supplements or coordinates with the features of one or more applications running on the POD host device. The POD application may, for example, be stored in programmable logic of processor 61 (FIG. 6), or in storage 62 of POD module 15 (FIG. 6). In other embodiments, the POD application may run on POD host device 12 or cooperatively on both POD module 15 and POD host device 12.

The POD application may be provided on the POD module initially, or may be downloaded after the POD module is inserted. In some embodiments, the POD host device may detect the insertion or connection of a POD module, download a POD application from the service provider and store the POD application in storage 62 (FIG. 6).

In some embodiments, the POD application may allow the user to configure the POD module upon insertion into or connection to the POD host device. The POD application may provide the user with various display screens for configuring the POD module, configuring the features provided by the POD module, or any other suitable display screen. For example, the POD application may allow the user to regulate which inputs from the remote control are transmitted directly to the POD module (e.g., as opposed to transmitting to the POD host device). In another example, the POD application may allow the user to register the POD module. Registering the POD module may include, for example, prompting the user to input user information (e.g., name, address, e-mail address, credit card information, etc.).

In some embodiments, the POD application may provide features to an interactive television application running on the POD host device or another piece of user equipment. The interactive television application may make function calls to the POD application via a POD application programming interface (API). The API may provide functions that, for example, allow another application to access platform resources (e.g., set-top box resources and/or server resources) such as on-screen display resources, remote control key resources, set-top box front-panel resources, communications channel resources, memory function resources, and other resources. The API may also allow an interactive television application to retrieve decryption keys from the POD module. One example of a suitable interactive television application that may use features of a POD module is an interactive television program guide. Examples of the various interactive television program guide interface screens are described, for example, in Ellis U.S. patent application Ser. No. 10/306,175, filed Nov. 25, 2002, which is hereby incorporated by reference herein in its entirety.

In some embodiments, the interactive television application may run on the POD module. POD modules containing an interactive television application may allow service providers to ensure that each user is provided with the same features regardless of the user's POD host device. In addition, providing an interactive television application on a POD module may allow service providers to maintain the same level of control as they currently have over their proprietary interactive television application provided on non-POD configured set-top boxes. In some embodiments, service providers may provide POD modules to update the interactive television application running on the host device. For example, a POD module containing updated software or upgraded circuitry may be delivered to each user (e.g., by mail). Service providers may request that users return unused POD modules, thereby allowing service providers to reprogram or reconfigure unused POD modules. In some embodiments, instead of replacing an entire POD module, system providers may upgrade existing POD modules by providing removable chips that may be inserted into POD modules.

The POD application may provide any feature suitable to the television experience that the POD module provider desires to provide, within the hardware and software constraints of the module itself. For example, a POD module may have a decryption key for a pay-per-view program. The POD application may decrypt or descramble a pay-per-view program in response to a request from the host device.

In some embodiments, a POD module may be programmed to implement parental control features. While most television systems are equipped with their own parental control systems, it may be desirable to effectively restrict programming and/or content using the POD module. For example, the POD module may provide users with the option of restricting access to all of the interactive television services (e.g., on-demand television, impulse pay-per-view, interactive shopping, or data services, etc.), all television programs, all programs with a TV-MA rating, all programs showing after 9:00 PM, all programs showing on a particular channel (e.g., MTV, Playboy, or BBC America) or any other suitable subset of programs. The POD application may be used to restrict the type of programming decrypted or decoded by the POD module. For example, although the POD module has decryption keys capable of decoding R-rated movies, the user may request that R-rated movies not be decoded before 10:00 PM. The POD application may also allow the user to input a personal identification number (PIN) for decoding programs. For example, in response to a user accessing a program that has to be decoded, the POD application may prompt the user to input a PIN number. If the user does not input the correct PIN number, the POD application may prevent programs from being decoded.

A locked or blocked program may not be viewable by another user until a POD module is inserted or connected that has the appropriate decryption key. For example, in response to changing channels to an adult-oriented channel, the interactive television application may determine whether the appropriate POD module having adult access decryption keys is inserted in or connected to the POD host device. In response to inserting the appropriate POD module, the POD module may unlock the user's POD host device and allow the locked content to be decrypted and viewed. Because the POD module decrypts most programming before it is displayed, the parental control system may accomplish this control by preventing the decryption of the restricted programming.

In some embodiments, the POD module may provide enhanced recording features. When recording a program, the POD application may record an identification code unique to the POD module along with the recorded program. When the user desires to play back the program, the same POD module must be inserted to play back the recorded program. When the user issues a play command, the POD application may transmit the POD identification code to the POD host device or other recording device. If the POD identification code from the currently inserted POD matches the POD identification code stored with the recorded program, the device will play back the program.

In some embodiments, a POD module may decode only those recordings that were encoded with that POD module. In response to receiving an encoded input the POD module may determine whether its identifier is recorded with the encoded recording. Alternatively, an interactive television application may perform this determination by requesting the identifier from the current module, comparing it to the identifier stored with the recording, and directing the POD module to decode the recording when a match exists.

In some embodiments, the interactive television application may allow only a registered user to view the encoded recording. In response to receiving a request from a user to play back an encoded recording, the interactive television application may determine whether the user equipment is registered to the user that created the encoded recording. In response to determining that the user equipment is registered to the same user that created the encoded recording, the interactive television application may allow the encoded recording to be decoded and viewed. This may allow a user to record a television program on one device (e.g., a television and recording device located in the user's living room) and view it on another device, such as a television and a recording device located in the user's bedroom.

The user may be required to register the user's user equipment by, for example, creating a user identification code that is stored in the POD module. The interactive television application may store the user identification code with an encoded recording to identify the user that created the recording and/or the user equipment that was used. In response to receiving a request from a user to play back the encoded recording, the interactive television application may retrieve the user identification code from the current POD host device and determine whether the current user identification code of the current POD host device matches with the user identification code stored in with the encoded recording. For example, the interactive television application may determine whether the POD host device is registered to the same user under the user identification code. In response to matching the user identification code, the interactive television application may direct the POD module to decode encoded recording.

In some embodiments, the interactive television application may allow the user to authorize multiple users to view the encoded recording. For example, the interactive television application may provide the user with a display screen for inputting information, such as, for example, usernames, e-mail addresses, time period, maximum number of users which may be provided with the key, payment options, etc. The interactive television application may also allow the user to specify a password for encoding the recorded program. In response to receiving user information and a password from the user, the interactive television application may provide each of the authorized users with the password, such as, for example, by e-mail.

In response to receiving the correct password from one of the authorized users, the interactive television application may direct the POD module to decode the encoded recording and playback the recording for the authorized user.

In some embodiments, the interactive television application may allow a user to view another user's encoded recording if that user is already authorized to view the program. For example, in response to receiving a request from an authorized user to record a program on an adult-oriented channel, the interactive television application may create an encoded recording of the program using the POD module. The user may allow another user to view or playback the encoded recording by giving the other user a DVD-R that has the encoded recording. When the second user inserts the DVD in his or her user equipment, the interactive television application may access that user's POD module to determine whether the user has access to the channel by, for example, retrieving the decryption keys stored in the POD module. If the user does not have access to the channel, the interactive television application may prevent the user from playing back the encoded recording. In some embodiments, the interactive television application may not decode the encoded recording. In another suitable embodiment, the interactive television application may destroy the encoded recording. For example, the interactive television application may erase the storage medium (e.g., a DVD-RW) that contains the encoded recording.

In some embodiments, encoding restrictions may be configured based at least in part on subscription level. For example, a user may be required to pay an extra monthly fee for the ability to record programming or to record programming in a less restricted manner (e.g., decoded format).

In some embodiments, encoding restrictions may be based on the programming to be recorded. For example, network television programs may permit any type of recording (e.g., decoded format), while paid cable programming may permit only a certain type of encoded programming (e.g., only the recorder or only the subscriber) and pay-per-view programming may prohibit any recording.

In some embodiments, encoding restrictions may be based on service fees. For example, in response to the user requesting to record a program, the POD module may charge a fee for the right to perform the recording based on the encoding restrictions. The interactive television application may prompt the user to input billing information for recording the program. In another example, a user desiring to view an encoded recording may be charged a fee before the encoded recoding may be viewed. The interactive television application or the service provider may also place restrictions on each encoded recording. For example, the service provider may limit the number of times or duration during which a recording may be viewed. For example, a particular recording may only be played back twice. In another example, a particular recording may only be viewed within a week from when the program was recorded.

It should be noted that the previous examples of providing secure recording and viewing of secure recordings are merely illustrative. In some embodiments, the service provider (e.g., a television broadcaster, a cable provider, a user producing the recording, etc.) may encode the desired approach on the POD module. For example, the service provider may encode instructions on the POD module that specify allowing all recordings to be made in a decoded format, encoded format for the exclusive use of the recorder, encoded format for the exclusive use of any subscriber, or any other suitable encoding restriction. In embodiments where recording and playback is performed under the control of an interactive television application, the interactive television application may query the POD module for the encoding restrictions, and control recording according to those restrictions.

Programs may be decoded, whether during real-time viewing by the user, or on playback from a storage device, using decryption keys. These keys may be generic to any POD module or may be programmed in each individual POD module, group of POD modules, or class of POD modules. A POD module may contain one or more decryption keys for accessing encoded programming, services, and/or other suitable information that the user has subscribed. Keys may be re-programmed or added, for example, at a predetermined time (e.g., every day, every week, every month, etc.) by the service provider as a security measure or to modify a user's access. Keys may also be distributed to users for particular events, such as special pay-per-view events, which are valid for that particular event.

In some embodiments, decryption keys to be stored in the POD module may be received from the service providers through a transmission over the cable line, such as, for example, in an out-of-band broadcast. In some embodiments, decryption keys may be embedded or encoded onto a POD module by the POD host device. For example, the POD host device may also have the ability to program decryption keys into the inserted POD module by, for example, using an EEPROM writer. Alternatively, keys may be alpha-numeric codes that may be relayed to the user, such as, for example, on the telephone, by mail, over the Internet, or by displaying the keys on the display device (e.g., television).

In some embodiments, keys necessary to decode programs and information may also be used to encode and decode recordings. For example, in response to receiving a request from a user to record a program, the interactive television application may record the keys and the program in an encoded format. In response to the user requesting to play back the recording program, the interactive television application may determine whether the keys in the POD module allow the user to decode and play back the encoded recording. For example, the interactive television application may use the API to retrieve the keys stored in the POD module.

In some embodiments, decryption keys may be available upon request. For example, the interactive television application may charge a fee for viewing a particular encoded recording, or a service provider may use decryption keys to track which programs are being recorded. The user may purchase or request the decryption key from the service provider. In another suitable approach, the interactive television application may provide the user with the key on a display screen. In some embodiments, the interactive television application may transmit the user's request for the key and payment information to the service provider using the back-channel device or communications circuitry 111 (FIG. 6). The service provider may then transmit the requested key to the POD module through the back-channel and communications circuitry 111 (FIG. 6). In other system configurations, the interactive television application may prompt the user to order the key by mail, over the telephone, or by accessing a web site over the Internet.

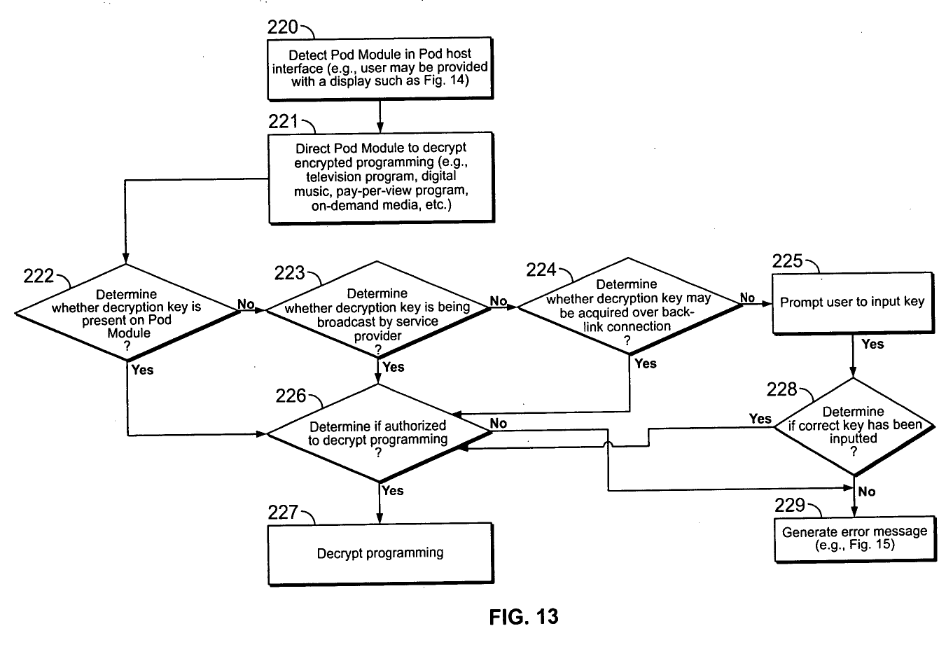

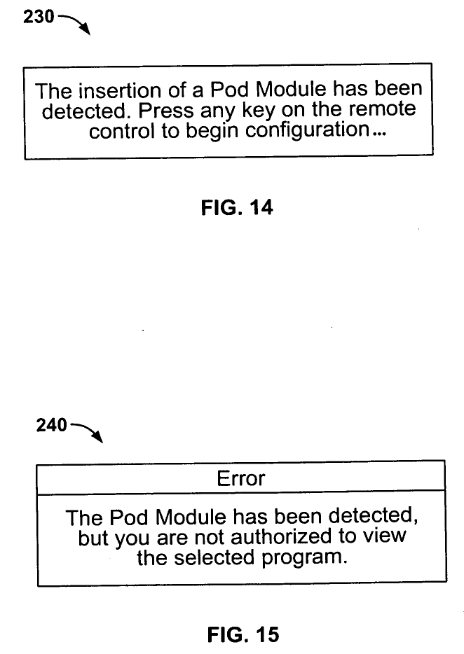

FIG. 13 shows an illustrative method for decrypting or decoding an encoded program in accordance with various embodiments of the present invention. At step 220, the interactive television application may automatically detect that a POD module has been inserted into the POD host device. For example, the interactive television application may provide the user with a display screen, such as display screen 230 as shown in FIG. 14. Display screen 230 may provide the user with a message, such as, for example “The insertion of a POD module has been detected. Press any key on the remote control to begin configuration.” In some embodiments, if the interactive television application has not detected the presence of a POD module, the user may direct the interactive television application to read the inserted POD module.

In response to detecting the POD module, the interactive television application may read the POD module and determine the services enabled by the POD module. At step 221, the interactive television application may direct the POD module to decrypt encoded programming (e.g., a television program, a recorded program, digital music, a pay-per-view program, on-demand media, a video game, etc.).

In order to decrypt or decode an encoded program or media, the interactive television application may receive a decryption key. For example, the interactive television application may use the API to retrieve the keys stored in the POD module. At step 222, the interactive television application may determine whether the decryption key is located on the POD module. If the decryption key is not located on the POD module (e.g., in storage 62), the interactive television application may determine whether the decryption key has been broadcast by the service provider at step 223. If the decryption key is not being broadcast by the service provider, the interactive television application may determine whether the decryption key may be obtained over a back-channel connection at step 224.

If the decryption key is located on the POD module, broadcast by the service provider, or obtained over a back-channel connection, the interactive television application may determine whether the user is authorized to decrypt the program at step 226. For example, with an encoded recorded program the interactive television application may determine whether the user is a subscriber (e.g., if the user is an subscribed to the pay-per-view event when the encoded program contains content from the pay-per-view event). In response to the interactive television application determining that the user has authorization to decrypt the program, at step 227, the interactive television application may decrypt or may direct the POD module to decrypt the encoded program and output the program to a display device.

If the decryption key is not located on the POD module, broadcast by the service provider, or obtained over a back-link connection, the interactive television application may prompt the user to enter a decryption key at step 225. In some embodiments, the interactive television application may prompt the user to enter a decryption key, or a location to find the decryption key (e.g., a directory on the hard drive or other storage device, a particular POD module, etc.). At step 228, in response to entering a decryption key or a location, the interactive television application may determine if the correct key has been obtained for decrypting the encoded program. If the correct key has been obtained, the interactive television application may determine whether the user is authorized to decrypt the encoded program (step 226) and, when authorized, decrypt and display the program to a display device (step 227).

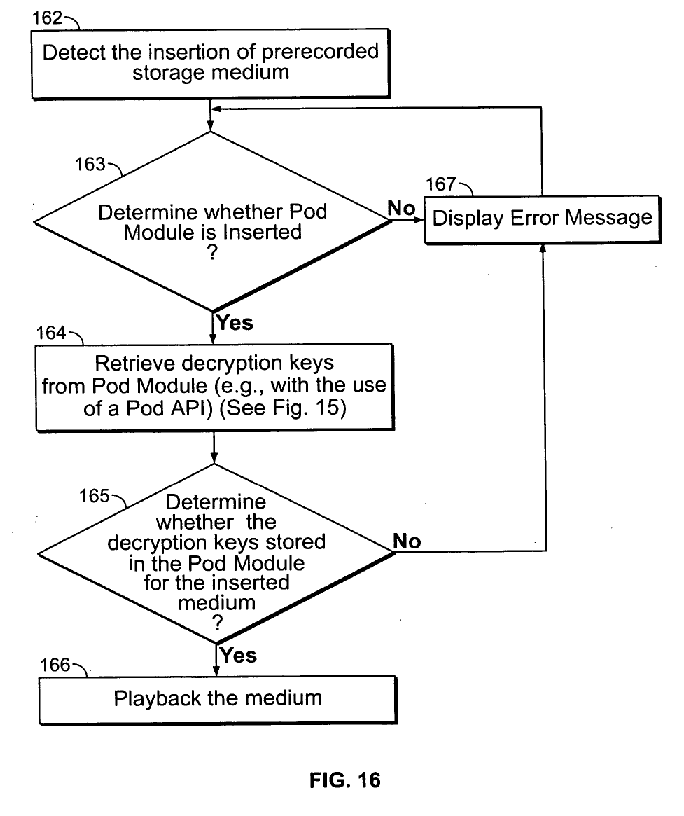

In some embodiments, if the correct key has not been obtained or if the user is not authorized to decrypt the encoded program, the interactive television application may provide the user with an error message (step 229). For example, as shown in FIG. 15, the interactive television application may provide the user with an illustrative error display screen 240. Display screen 240 may provide the user with a message, such as, for example, “Error. The POD module has been detected, but you are not authorized to view the selected program.”

In some embodiments, POD modules may be used to decode or decrypt encoded commercial video recordings, such as DVDs. For example, special advanced releases of movies are distributed to a select group of individuals which are frequently stolen, copied, and/or sold illegally. Using POD modules, such DVDs may be accessed by only the users that are authorized to play back the DVD. In some embodiments, each of the intended users may be provided with a particular POD module having the decryption keys. In response to the intended user inputting the DVD into a DVD player and the associated POD module into a POD slot of the POD host device, the interactive television application may allow the user to play back the encoded DVD.

FIG. 16 shows an illustrative method for decrypting or decoding encoded media in accordance with some embodiments of the present invention. At step 162, the interactive television application may automatically detect that a prerecorded storage medium (e.g., a videocassette, a digital video disc, a compact disc, etc.) has been inserted into the POD host device, such as a recording device. In response to detecting the insertion of a storage medium, the interactive television application may detect whether a POD module has been inserted into the POD host device at step 163. In response to detecting that a POD module has been inserted, the interactive television application may read the POD module and retrieve the decryption keys stored in the POD module at step 164. For example, the interactive television application may use a POD API to retrieve the decryption keys.

At step 165, the interactive television application may determine whether the decryption keys stored in the POD module correspond to the keys for the inserted medium. For example, the interactive television application may compare the keys stored in the POD module with the keys encoded on the medium. Any of several techniques may be used to determine whether the appropriate POD module has been inserted to playback the inserted medium. For example, a look-up table of the decryption keys needed to playback the medium may be used.

In response to the interactive television application retrieving the necessary decryption keys from the POD module, the interactive television application may playback the inserted medium at step 166.

In response to the interactive television application determining that the decryption keys needed to playback the inserted medium are not stored in the POD module, or determining that a POD module has not been inserted, the interactive television application may provide the user with an error message (step 167). The error message may, for example, instruct the user to insert the correct POD module.

In another example, it would be desirable to allow users to rent a DVD without having to return it. For example, a video rental store (e.g., a brick-and-mortar store or an Internet retailer) may provide a user with an encoded DVD for use with a POD module. The encoded DVD may allow the user to watch the DVD for a certain period of time, a certain number of times, or a certain number of times over a certain period of time in response to inserting both the encoded DVD and the POD modules. After the period of time has elapsed or after the number of time has been exceeded, the encoded DVD would not permit the user to play back the DVD. In some embodiments, the POD module may be used once to provide playback of the limited-use DVD. In another embodiment, the user's membership card to the video rental store may be integrated with a POD module. When the user purchases a DVD, the user's membership card may be encoded with the necessary decryption keys to playback the purchased limited-use DVD. However, the user may also be provided with the appropriate keys using any other suitable approach.

In some embodiments, a service provider may provide pre-paid services (e.g., pre-paid basic cable) on POD modules (also referred to as “pre-paid POD modules”). Pre-paid POD modules may be disposable. A new POD module may be purchased with each pre-paid service. Pre-paid POD modules may also be reusable. For example, a reusable POD module may be re-activated by inserting a new chip, such as an EEPROM or Flash chip, into the POD module or by entering a new key or code. Reusable pre-paid POD modules may also be activated and re-activated using any other suitable approach.

Some users may desire to have the flexibility of a pre-paid service. Users may purchase different levels of service for different amounts of time. Service may be provided by the season, month, week, day, hour, or even episode. Users may start, stop, and change their cable service by purchasing pre-paid POD modules. Such a service may be beneficial to users who do not wish or do not have suitable credit to establish an account.

Pre-paid POD modules may be purchased by users who want access to cable television when they are on vacation from work or school or by users that travel frequently and do not desire a regular cable subscription. While these pre-paid POD modules may be used to receive general cable services, it may also be used for premium services. For example, a user may purchase a pre-paid POD module that allows the user to receive pay-per-view movies. These POD modules may be accessible to non-cable subscribers that want access to the selection of movies offered by cable television but do not wish to subscribe, or to cable users who do not wish their pay-per-view selection to be charged to their monthly bill. In another example, a user may purchase a pre-paid POD module to gain access to an entire season of a particular television series, such as, “The Sopranos.”

In some embodiments, users may be charged different rates based on whether or not they are subscribers. For example, retailers may sell pre-paid access to services by time (e.g., a POD module for one week of service), by amount paid (e.g., a POD module for fifty dollars worth of service), or by service type. Pre-paid POD modules may be also be combined with subscription services to increase the options of subscribers.

In one suitable approach, the pre-paid POD modules may be used once and expire after a pre-determined about of time. In some embodiments, a disposable POD module may be provided from less expensive components and circuitry such that the POD module contains the minimum number of components (e.g., only a decryption circuit).

POD modules may provide a period of time during which premium channels are offered for free to current subscribers to entice them to upgrade their services. For example, service providers may provide users with POD modules that provide a week of premium cable television service. Service providers may distribute these POD modules in using any suitable approach. For example, disposable POD modules may be sent in the mail, inserted in a magazine, or provided in connection with the purchase of consumer electronics.

In some embodiments, POD modules may be easily transferred between multiple POD host devices. For example, a user may bring his POD module to watch premium television at another location (e.g., a friend's house who is not a cable subscriber). A user who travels frequently or has multiple residences may also be able to use the same cable service in multiple locations by using the same POD module in each location. In other embodiments, a POD module may only be used with select POD host devices. The select POD host devices may based on location (e.g., only in the user's home or only in the user's local cable service area) or based on the POD host device being registered with the service provider. The level of portability of the POD module may also be based on a user's subscription level (e.g., the user may pay extra per POD host device authorized to use the POD module). According to some embodiments, generic, pre-paid, disposable, and non-subscription based POD modules may be used in any suitable POD module without any special configuration.

In some embodiments, users may be provided with the ability to use a POD module in an unauthorized or unregistered POD host device. Instead of blocking a user from using a POD module in an unauthorized or unregistered POD host device at a different location, the service provider may charge a fee for this usage (e.g., a “roaming” charge). This fee may be a single fee, may be based on the duration of use, or may be based on the programming or services accessed. For example, a user has a POD module that provides him with access to premium cable services. The POD module is also encoded for use only with that user's set-top box. When that user inserts his POD module into, for example, a second user's personal computer at another location, the personal computer may detect that the POD module has been inserted. In response, the interactive television application may prompt the second user to pay a fee for accessing services on the first user's POD module that the second user is not authorized to receive. For example, the interactive television application may generate a display message informing the user of the fees. In some embodiments, the interactive television application may require that the user consent to being charged those fees. The generated display may also prompt the user to enter suitable billing information (e.g., name, address, telephone number, credit card information, etc).

In some embodiments, POD modules may be used to support a video game system. In one example, one or more games may be encoded onto a POD module. User input for the video game may be received through a general or special IR remote controller device that communicates with the user equipment or may be connected directly to the POD host device. In another example, games for the video game system may be on separate POD modules (e.g., for multiple POD module systems).

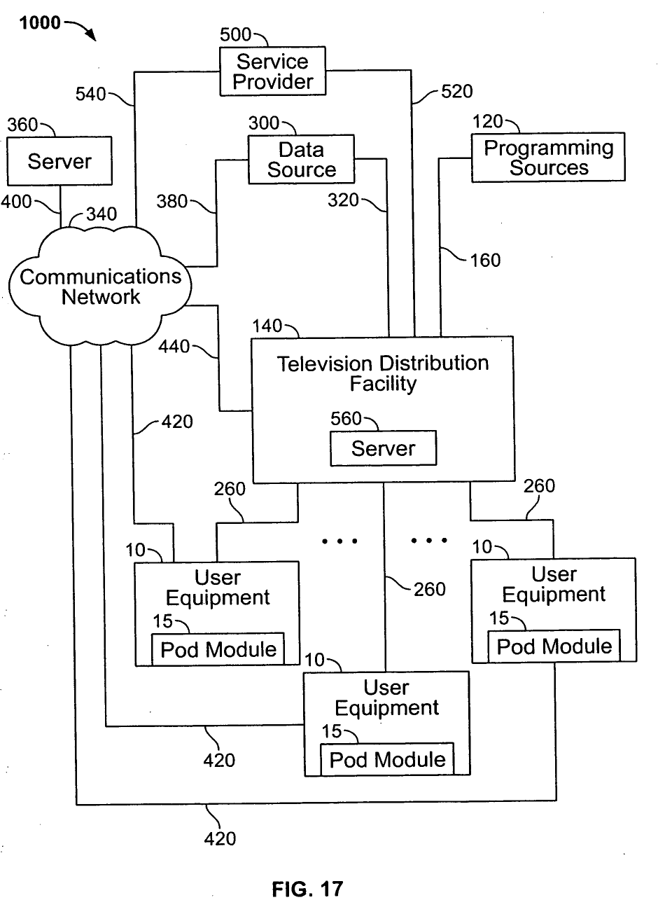

For purposes of illustration, an interactive television system 1000 that may support the use of POD modules in connection with an interactive television program guide is shown in FIG. 17.

Content such as television programming and other media, such as digital music may be provided from programming sources 95 to television distribution facilities such as television distribution facility 140 using communications path 160. Programming sources 95 may be any suitable sources of television and music programming and other information, such as television and music production studios, etc.

Television distribution facility 140 may be a cable system headend, a satellite television distribution facility, a television broadcast facility, or any other suitable facility for distributing television and music programming to users. There are typically numerous television distribution facilities 140 in system 1000, but only one is shown in FIG. 17 to avoid overcomplicating the drawings.

Communications path 160 may be a satellite path, a fiber-optic path, a cable path, or any other suitable wired or wireless communications paths or a combination of such paths.

Television distribution facility 140 may be connected to various user equipment devices 10. Such user equipment 10 may, for example, be located in the homes of users. User equipment 10 includes POD module 15. User equipment 10 may receive television and music programming and other information from television distribution facility 140 over communications path 260. User equipment 10 may also transmit signals to television distribution facility 140 over path 260. Path 260 may be cables or other wired connections, or wireless connections for broadcast or satellite links. The interactive television program guide is implemented (at least partially) on user equipment 10.

Data source 300 may include a program listings database that is used to provide the user equipment 10 with information for the interactive television program guide, such as scheduled broadcast times, titles, channels, ratings information (e.g., parental ratings and critic's ratings), detailed title descriptions, genre or category information (e.g., sports, news, movies, etc.), information on actors and actresses, running times, etc. Data source 300 may also be used to provide advertisements (e.g., program guide advertisements and advertisements for other interactive television applications), real-time data such as sports scores, stock quotes, news, weather, etc. Although data source 300 is drawn as an individual box in FIG. 17, data source 300 and the other system components of FIG. 17 may be provided using equipment at one or more locations. System components are drawn as single boxes in FIG. 17 to avoid over-complicating the drawings.

Data source 300 may provide program schedule information and other data to television distribution facility 140 over communications path 320 for distribution to associated user equipment 10 over path 260. Communications path 320 may be any suitable communications path such as a satellite communications path or other wireless path, a fiber-optic or other wired communications path, a path that supports Internet communications, a combination of such paths, etc. Data source 300 may provide program schedule information and other data to the user at user equipment 10 over path 380, communications network 340, and path 420. Path 420 may be a wired path such as a telephone line, a cable path, a fiber-optic path, a satellite path, a wireless path, a combination of such paths, or any other suitable path.

An on-line program guide and other interactive television services may be provided using a server connected to communications network 340 such as server 360. Server 360 may receive program schedule information and other data from data source 300 via communications path 380, communications network 340, and communications path 400. Paths 380 and 400 may be satellite paths, fiber-optic paths, wired paths, etc. Communications network 340 may be any suitable communications network, such as the Internet, the public switched telephone network, a packet-based network, etc.

User equipment 10 may access on-line program guide information and other information from server 360 via communications path 420. User equipment 10 may also access the on-line program guide and other services on server 360 via communications path 260, television distribution facility 140, and communications path 440. For example, a cable modem or other suitable equipment may be used by user equipment 10 to communicate with television distribution facility 140. Television distribution facility 14 may communicate with communications network 340 over any suitable path 440, such as a wired path, a cable path, fiber-optic path, satellite path, a combination of such paths, etc.

Program guide application functions and the functions of other interactive television applications may be supported using server 360 and other servers connected to communications network 340 such as server 560. Interactive television applications may also be supported by servers or other suitable equipment at one or more service providers, such as service provider 500. For example, a home shopping service may be supported by a service provider such as service provider 500 that has sales representatives, order fulfillment facilities, account maintenance facilities, and other equipment for supporting interactive home shopping features. A home shopping application that is implemented using the user equipment may be used to access the service provider to provide these features to the user. The user equipment may access service provider 500 via television distribution facility 140 and communications path 520 or via communications network 340 and communications path 540. Communications paths such as paths 520 and 540 may be any suitable paths, such as wired paths, cable paths, fiber-optic paths, satellite paths, a combination of such paths, etc.

Another example of an interactive television application is a home banking application. A home banking service may be supported using personnel at facilities such as service provider 500. An interactive home banking application that is implemented using the user equipment may access the home banking service via television distribution facility 140 and communications path 520 or via communications network 340 and communications path 540.

If desired, an interactive television application such as a network-based video recorder or a video-on-demand application may be supported using server 560, server 360, or equipment at service provider 500. Video-on-demand content and video recorded using a network-based video recorder arrangement may be stored on server 560 or server 360 or at service provider 500 and may be provided to the user equipment when requested by users. An interactive television application may be used to support the functions of a personal video recorder (sometimes called a digital video recorder) that is implemented using user equipment 10. Illustrative equipment that may be used to support personal video recorder functions include specialized personal video recorder devices, integrated receiver decoders (IRDs), set-top boxes with integrated or external hard drives, or personal computers with video recording capabilities.

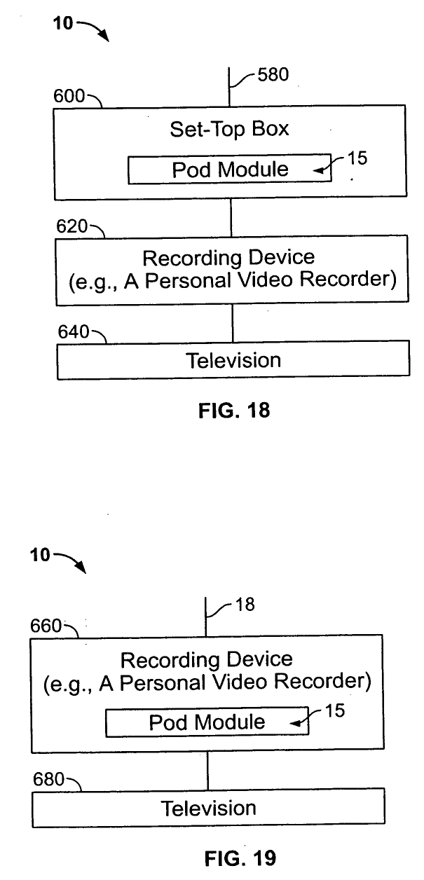

User equipment 10 may include POD module 15 for providing programming and the interactive features described herein. FIGS. 18-20 show illustrative arrangements of user equipment 10 for supporting POD module 15. FIG. 18 shows a set-top box arrangement. In this arrangement, input/output 580 may be connected to communication paths, such as paths 260 and 420 (FIG. 17). Input/output functions may be provided by one or more wires or communications paths, but are shown as a single path in FIG. 18 to avoid overcomplicating the drawing. Television programming and other information may be received using input/output 580.

Set-top box 600 may be any suitable analog or digital set-top box (e.g., a cable set-top box). Set-top box 600 may contain an analog tuner for tuning to a desired analog television channel. Set-top box 600 may also contain digital decoding circuitry for receiving digital television and music channels. Both analog and digital channels may be handled together if desired. Multiple tuners may be provided (e.g., to handle simultaneous watch and record functions). Set-top box 600 may be an integrated receiver decoder (IRD) that handles satellite television. If desired, set-top box 600 may have circuitry for handling cable, over-the-air broadcast, and satellite content. Set-top box 600 may include a storage device (e.g., a digital storage device such as a hard disk drive) for providing recording capabilities. Set-top box 600 may also be connected to a recording device 620 such as a video cassette recorder, personal video recorder, or other devices with storage capabilities.

Set-top box 600 contains a processor (e.g., a microcontroller or microprocessor or the like) that is used to execute software applications. The processor described as being located within set-top box 600 is omitted from FIG. 18 in order to avoid unnecessarily complicating the figure. Set-top box 600 may contain memory such as random-access memory for use when executing applications. Nonvolatile memory may also be used (e.g., to launch a boot-up routine and other instructions). Hard disk storage in box 600 or in recording device 620 may be used to back up data and in otherwise support larger databases and storage requirements than may be supported using random-access memory approaches.

Set-top box 600 may have infrared (IR) or other communications circuitry for communicating with a remote control or wireless keyboard. Set-top box 600 may also have dedicated buttons and a front-panel display. The front-panel display may, for example, be used to display the current channel to which the set-top box is tuned.

Set-top box 600 may also have communications circuitry such as a cable modem, an integrated services digital network (ISDN) modem, a digital subscriber line (DSL) modem, a telephone modem, wireless modem, etc. for communications with other equipment. Such communications may involve the Internet or any other suitable communications networks or paths. If desired, the components of set-top box 600 may be integrated into other user equipment (e.g., a television or videocassette recorder).

Set-top box 600 may also be adapted to receive POD module 15. For example, when POD module 15 is correctly connected to set-top box 600, decryption circuitry (not shown) in POD module 15 may authorize and de-authorize the decryption or descrambling of services, such as programming, interactive television services, digital music, and events, delivered through the set-top box 600.

Recording device 620 may be used to record videos provided by set-top box 600. For example, if set-top box 600 is tuned to a given television channel, the video signal for that television channel may be passed to recording device 620 for recording on a videocassette, compact disc, digital video disk, or internal hard drive or other storage device. Recording device 620 may have communications circuitry such as a cable modem, an ISDN modem, a DSL modem, a telephone modem, etc. for communications with other equipment. Such communications may involve the Internet or any other suitable communications networks or paths. The components of recording device 63 may be integrated into other user equipment (e.g., a television, stereo equipment, etc.).

Recording device 620 may be controlled using a remote control or other suitable user interface. If desired, video recorder functions such as start, stop, record, etc. and other functions for device 620 may be controlled by set-top box 600. For example, set-top box 600 may control recording device 620 using infrared commands directed toward the remote control inputs of recording device 620 or set-top box 600 may control recording device 620 using other wired or wireless communications paths between box 600 and device 620.

The output of recording device 620 may be provided to television 640 for display to the user. If desired, multiple recording devices 620 or no recording device 620 may be used. If recording device 620 is not present or is not being actively used, the video signals from set-top box 600 may be provided directly to television 640. Any suitable television or monitor may be used to display the video. In the equipment of FIG. 18 and the other equipment of system 10, the audio associated with various video items is typically distributed with those video items and is generally played back to the user as the videos are played.

Another illustrative arrangement for user equipment 10 is shown in FIG. 19. In the example of FIG. 19, user equipment 10 includes a recording device 660 such as a digital video recorder (e.g., a personal video recorder (PVR)) that uses a hard disk or other storage for recording video or may be a digital video disc recorder, compact disc recorder, videocassette recorder, or other suitable recording device. User equipment 10 of FIG. 19 may also include a television 680. Input/output 700 may be connected to communications paths such as paths 270 and 460. Television programming and other information may be received using input/output 700. Commands and requests and other information from the user may be transmitted over input/output 700.

Recording device 660 may contain at least one analog tuner for tuning to a desired analog television channel (e.g., multiple tuners may be provided). Recording device 660 may also contain digital decoding circuitry for receiving digital television and music channels. If desired, recording device 660 may contain circuitry for handling both analog and digital channels. Recording device 660 also contains a processor (e.g., a microcontroller or microprocessor or the like) that is used to execute software applications. Recording device 660 may contain memory such as random-access memory for use when executing applications. Nonvolatile memory may also be used to store a boot-up routine or other instructions. The hard disk and other storage in recording device 660 may be used to support databases (e.g., program guide databases or interactive television application databases). The hard disk or other storage in recording device 660 may also be used to record video such as television programs or video-on-demand content or other content provided to recording device 660 over input/output 700.

Recording device 660 may have IR communications circuitry or other suitable communications circuitry for communicating with a remote control. Recording device 660 may also have dedicated buttons and a front-panel display. The front-panel display may, for example, be used to display the current channel to which the recording device is tuned.

Recording device 660 may also have communications circuitry such as a cable modem, an ISDN modem, a DSL modem, a telephone modem, a wireless modem, etc. for communications with other equipment. Such communications may involve the Internet or other suitable communications networks or paths.

Recording device 660 may also be adapted to receive POD module 15. For example, when POD module is correctly connected to recording device 660, decryption circuitry (not shown) in POD module may authorize and de-authorize the decryption or descrambling of recorded programs to be played back using recording device 660.

If desired, recording device 660 may include a satellite receiver or other equipment that has wireless communications circuitry for receiving satellite signals.

Recording device 660 of FIG. 19 or recording device 620 of FIG. 7 may record new video while previously recorded video is being played back on television 690 or 640. This allows users to press a pause button during normal television viewing. When the pause button is pressed, the current television program is stored on the hard disk of digital video recorder 660. When the user presses play, the recorded video may be played back. This arrangement allows the user to seamlessly pause and resume television viewing. Recording device 660 and 620 may also be used to allow a user to watch a previously-recorded program while simultaneously recording a new program.

It should also be noted that the set-top box arrangement of FIG. 18 and the digital video recorder set-top box arrangement of FIG. 19 are merely illustrative. For example, user television equipment may be based on a WebTV box, a personal computer television (PC/TV), or any other suitable television equipment arrangement. If desired, the functions of components such as set-top box 600, digital video recorder 660, a WebTV box, or PC/TV or the like may be integrated into a television or personal computer or other suitable device.

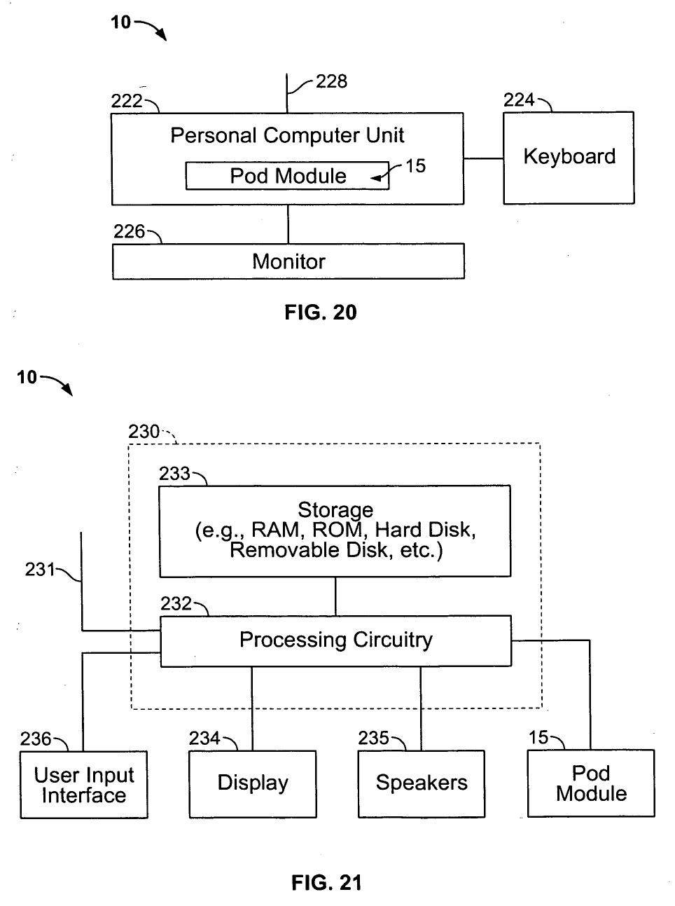

FIG. 20 shows a personal computer based arrangement for user equipment 10. In the arrangement of FIG. 20, personal computer unit 222 may be controlled by the user using keyboard 224 or other suitable user input device, such as a trackball, mouse, touch pad, touch screen, voice recognition system, a remote control, etc. Video content such as television programming and interactive television application display screens may be displayed on monitor 226. Television programming, video-on-demand content, video recordings played back from a network-based video recorder, and other information may be received from paths 280 and 480 (FIG. 17) using input/output 228. The user may also send commands and other information used during interactions with the interactive television application and system 1000 over input/output line 228.

Personal computer unit 222 may contain a television or video card such as television tuner card for decoding analog and digital television channels and for handling streaming video content. Multiple video cards (e.g., tuner cards) may be provided if desired. An illustrative television tuner card that may be used may contain an analog television tuner for tuning to a given analog channel and digital decoding circuitry for filtering out a desired digital television or music channel from a packetized digital data stream. Any suitable card or components in computer unit 222 may be used to handle video and other content delivered via input/output line 228 if desired.

Personal computer unit 222 may contain one or more processors (e.g., microprocessors) that are used to run the interactive television application or a portion of the interactive television application.

Personal computer unit 222 may be adapted to receive POD module 15. For example, when POD module is correctly connected to personal computer unit 222, POD module 15 may provide the user with Internet access delivered through personal computer unit 222.

Video recording functions may be provided by the interactive television application in a personal video recorder arrangement or a network-based video recorder arrangement, or any other suitable arrangement.

In a personal video recorder arrangement, storage in personal computer unit 222 may be a hard drive, digital versatile disc recordable (DVD-R) drive, digital versatile disc rewritable (DVD-RW) drive, compact disc recordable (CD-R) drive, compact disc rewritable (CR-RW) drive, or other suitable storage device or devices for storing video and other content. The interactive television application and personal computer unit 222 may use this storage to provide the functions of a personal video recorder.

Network-based video recording functions may be provided using a combination of user equipment 10 (FIG. 17) and network equipment. Network equipment may be, for example, server 560, server 360, or equipment at service providers such as service provider 500 of FIG. 17. Video recording functions may be provided by storing copies of television programs and other video content on a remote server (e.g., server 560 or server 360 of FIG. 17) or other network-based equipment such as equipment at a service provider such as service provider 500.

Video recordings may be made in response to user commands that are entered at user equipment 10. In a personal video recorder arrangement, the interactive television application may be used to record video locally on the user equipment in response to the user commands. In a network-based video recorder arrangement, the interactive television application may be used to record video or to make virtual recordings on network equipment such as server 360, 560, or equipment at service provider 500 in response to the user commands. The user commands may be provided to the network equipment over the communications paths shown in FIG. 17. The personal video recorder arrangement and the network-based video recorder arrangement can support functions such as fast-forward, rewind, pause, play, and record.

To avoid unnecessary duplication in a network-based video recorder environment, the system 1000 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area.

FIG. 21 shows a more generalized embodiment of illustrative user equipment. Control circuitry 230 is connected to input/output 231. Input/output 231 may be connected to one or more communications paths such as paths 260 and 420 of FIG. 17. Television and music programming may be received via input/output 231 (e.g., from programming sources 95, servers or other equipment such as server 360, service providers such as service provider 500, and television distribution facility 140). Program schedule information for an interactive television application may be received from data source 300 via input/output 231. Input/output 231 may also be used to receive information transmitted by data source 300 for other interactive television applications. The user may use control circuitry 230 to send commands, requests, and other suitable information using input/output 231.

Control circuitry 230 may be based on any suitable processing circuitry 232 such as processing circuitry based on one or more microprocessors, microcontrollers, digital signal processors, programmable logic devices, etc. Memory (e.g., random-access memory and read-only memory), hard drives, DVD drives, CD drives, or any other suitable memory or storage devices may be provided as storage 233 that is part of control circuitry 230. Tuning circuitry such as one or more analog tuners, one or more MPEG-2 decoders or other digital video circuitry, or any other suitable tuning or video circuits or combinations of such circuits may also be included as part of circuitry 230. Encoding circuitry (e.g., for converting over-the-air or cable analog signals to MPEG signals for storage) may also be provided. The tuning and encoding circuitry may be used by the user equipment to receive and display or play or record a particular television or music channel or other desired audio and video content (e.g., video-on-demand content or requested network-based or local video recorder playback). Television programming and other video and on-screen options and information may be displayed on display 234. Display 234 may be a monitor, a television, or any other suitable equipment for displaying visual images. Speakers 235 may be provided as part of a television or may be stand-alone units. Digital music and the audio component of videos displayed on display 234 may be played through speakers 235.

A user may control the control circuitry 230 using user input interface 236. The user input interface 236 may be any suitable user interface, such as a mouse, trackball, keypad, keyboard, touch screen, touch pad, voice recognition interface, remote control, etc.

POD module 15, as described above, may be provided. For example, when POD module is correctly connected to user equipment 10, decryption circuitry (not shown) in POD module may authorize and de-authorize the decryption or descrambling of services, such as programming, interactive television services, digital music, and events, delivered through the user equipment using input/output 231.

POD module 15, using, for example processor 61 (FIG. 6), may communicate with processing circuitry 232 of control circuitry 230. POD module 15 may, for example, direct processing circuitry 232 to use the tuning circuitry to tune the user equipment to an out-of-band channel such that POD module 15 may receive configuration data.

In another arrangement (not shown), POD module 15 may be connected to display 234 and speakers 235. POD module 15 may include video generating circuitry that generates a video stream and transmits the video stream to display 234 without any assistance, configuration, or instructions from processing circuitry 232. POD module 15 may replace the video that display 234 is currently displaying with the video that POD module 15 is generating.

In still another arrangement (not shown), POD module 15 may be connected to storage 233. Storage 233 may supplement storage in POD module 15, such as storage 62 (FIG. 6). For example, if storage 233 is an SDRAM chip, it may supplement the internal memory of POD module 15.

In yet another arrangement (not shown), POD module 15 may be connected to user input interface 236 to receive user input. For example, POD module 15 may include circuitry, such as IR receiver 87 and IR blaster 88 (FIG. 7) that receives commands from user input interface 236. If, for example, POD module 15 receives a command from user input interface 236 that is related a record operation, POD module 15 may transmit a signal to the IR receiver of a recording device. In another example, POD module 15 may direct processing circuitry 232 to transmit the signal to the recording device.

Thus, interactive television systems having POD modules, and methods for use in the same, are provided. It will be understood that the foregoing is only illustrative of the principles of the invention and that various modifications can be made by those skilled in the art without departing from the scope and spirit of the invention.

1. An interactive television system that provides television programming to a plurality of users over communications paths, the system comprising:
user equipment that is adapted to receive a point of deployment module;
at least one point of deployment module that is configured to be inserted into the user equipment; and
a communications device external to the user equipment and the at least one point of deployment module.

2. The interactive television system of claim 1 wherein the communications device comprises a back-channel device operative to connect the point of deployment module to a service provider.

3. The interactive television system of claim 2 wherein the back-channel device couples an input signal from a service provider to the at least one point of deployment module.

4. The interactive television system of claim 3 wherein the back-channel device comprises:
a signal tap;
a transmitter modulator; and
control circuitry.

5. The interactive television system of claim 4 wherein the control circuitry is at least partially controlled by the point of deployment module.

6. The interactive television system of claim 2 wherein the back-channel device is connected to the user equipment.

7. The interactive television system of claim 2 wherein the back-channel device is connected to the at least one point of deployment module.

8. The interactive television system of claim 7 wherein the connection between the back-channel device and the at least one point of deployment module comprises:
a transmit enable signal;
a clock signal; and
a transmission data signal.

9. The interactive television system of claim 8 wherein the transmission data signal is a differential signal.

10. The interactive television system of claim 2 wherein the back-channel device communicates with the service provider using a proprietary algorithm.

11. The interactive television system of claim 2 wherein the back-channel device communicates with the service provider using an ALOHA protocol.

12. The interactive television system of claim 1 wherein the communications device is selected from a group consisting of a cable modem, an ISDN modem, a DSL modem, a telephone modem, a network interface controller, a wireless network interface controller, and a wireless modem.

13. The interactive television system of claim 12 wherein the communications device is operative to connect the at least one point of deployment module to a service provider.

14. The interactive television system of claim 1 wherein the at least one point of deployment module has at least one connector configured to connect to the communications device.

15. The interactive television system of claim 1 wherein the communications device is operative to receive information from a service provider.

16. The interactive television system of claim 1 wherein the communications device is operative to transmit information to a service provider.

17. The interactive television system of claim 1 wherein the communications device is operative to receive information from a service provider over an out-of-band frequency.

18. The interactive television system of claim 1 wherein the communications device comprises an out-of-band tuner.

19. The interactive television system of claim 1 wherein the communications device transmits information to the at least one point of deployment module.

20. The interactive television system of claim 1 wherein the communications device transmits information to the user equipment.

21. The interactive television system of claim 1 wherein the at least one point of deployment receives information from the communications device.

22. The interactive television system of claim 1 wherein the user equipment receives information from the communications device.

23. The interactive television system of claim 1 wherein the communications device is at least partially embedded in the point of deployment module.

24. The interactive television system of claim 1 wherein the communications device is at least partially embedded in the user equipment.

25-104. (canceled)
